(19) United States
(12) Patent Application Publication
(10) Pub. No.: US 2026/0288886 A1
(43) Pub. Date: Sep. 24, 2026

(54) SYSTEM

(71) Applicant: SoftBank Group Corp., Tokyo (JP)

(72) Inventor: Shunpei SANO, Tokyo (JP)

(73) Assignee: SoftBank Group Corp., Tokyo (JP)

(21) Appl. No.: 19/562,884

(22) Filed: Mar. 11, 2026

(30) Foreign Application Priority Data
Mar. 19, 2025 (JP) 2025-044520

(51) Int. Cl. G06F 16/9536; G06F 40/295; G06N 3/0475

(52) U.S. Cl. CPC G06F 16/9536; G06F 40/295; G06N 3/0475

(57) ABSTRACT

A system includes a processor that is configured to receive an inquiry from a user and analyze a content of the inquiry, apply a predefined rule set based on a result of the analysis in order to route the inquiry to an appropriate service or expert, and document an interaction with a generative AI model by creating a prompt that instructs the generative AI model to generate a response corresponding to the content of the inquiry, and to store the generated response in a database.

### CROSS-REFERENCE TO RELATED APPLICATION

This application is based on and claims priority under 35 USC 119 from Japanese Patent Application No. 2025-044520 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional customer support and information-provision systems that utilize generative AI models often treat all user inquiries in a uniform manner without appropriately routing the inquiries to specialized services or human experts. As a result, inquiries that actually require expert judgment, such as legal, medical, or financial questions, may be inadequately handled only by an automated AI response, which can lead to reduced reliability and user dissatisfaction. In addition, even when past inquiries and responses are stored, many systems are not able to effectively reuse such stored interactions to accelerate response time or improve answer quality for new but similar inquiries. Furthermore, conventional systems generally do not consider the emotional state of the user when generating responses, and therefore may return answers that are technically correct but emotionally insensitive or inappropriate for users who are anxious, frustrated, or otherwise emotionally burdened. Accordingly, there is a need for a system that can analyze the content of a user inquiry, route the inquiry to an appropriate service or expert based on a predefined rule set, effectively leverage past stored interactions to provide rapid and relevant solutions, and adjust responses based on an analysis of the user's emotional state.

### SUMMARY

In order to solve at least part of the above-described problems, a system is provided that comprises a processor configured to receive an inquiry from a user and analyze a content of the inquiry. The processor is further configured to apply a predefined rule set based on a result of the analysis in order to route the inquiry to an appropriate service or expert. The processor is also configured to document an interaction with a generative AI model by creating a prompt that instructs the generative AI model to generate a response corresponding to the content of the inquiry, and to store the generated response in a database. In some embodiments, the processor is configured to refer to the stored database and provide a solution rapidly based on a past inquiry similar to the received inquiry, thereby improving response speed and answer quality by reusing accumulated interaction data. In some embodiments, the processor is further configured to analyze an emotional state of the user by using natural language processing technology and to generate the response based on a result of the analysis of the emotional state, thereby enabling responses that are adapted not only to the substantive content of the inquiry but also to the user's psychological condition.
The term “processor” refers to one or more hardware processing units, such as a central processing unit (CPU), graphics processing unit (GPU), digital signal processor (DSP), or any combination thereof, configured to execute instructions and perform the functions described in the claims.
The term “inquiry” refers to information, typically expressed in natural language, that is transmitted from a user to the system to request an answer, solution, clarification, or other form of assistance regarding a specific topic or problem.
The term “user” refers to an individual person or an entity, such as an organization or software agent acting on behalf of a person or organization, that operates a client device or interface to submit an inquiry to the system.
The term “analyze a content of the inquiry” refers to processing the text or other data included in the inquiry, for example by parsing, classifying, extracting features, or performing natural language understanding, in order to identify attributes such as topic, intent, domain, urgency, or required expertise.
The term “predefined rule set” refers to a collection of conditions, rules, or decision criteria that are prepared in advance and stored in the system, and that are applied by the processor to determine how to process or route an inquiry based on analysis results, such as inquiry category, user attributes, or detected risk level.
The term “route the inquiry to an appropriate service or expert” refers to selecting, based on the predefined rule set, at least one destination for further handling of the inquiry, such as a particular software service, backend module, workflow, or a human expert having relevant expertise, and causing the inquiry or its processed form to be delivered or assigned to that destination.
The term “service” refers to a software-based function, application, or backend module that performs processing related to an inquiry, such as information retrieval, transaction processing, workflow execution, or automated assistance distinct from the generative AI model.
The term “expert” refers to a human specialist or a designated expert resource having domain-specific knowledge or qualifications, such as a lawyer, doctor, financial advisor, or technical specialist, to whom an inquiry may be routed when automated handling is insufficient or not appropriate.
The term “generative AI model” refers to a machine learning model, such as a large language model or other generative model, configured to generate text or other content in response to an input prompt, based on patterns learned from training data.
The term “prompt” refers to data provided as input to the generative AI model, including instructions, context information, and the content of the user's inquiry, that directs the generative AI model to generate a response corresponding to the inquiry.
The term “response” refers to information generated by the generative AI model or otherwise produced by the system as an answer, recommendation, explanation, or other output that addresses the content of the user's inquiry.
The term “document an interaction with a generative AI model” refers to recording or structuring, in a data format, information related to the exchange between the system and the generative AI model, including at least the prompt and the corresponding response, and optionally associated metadata.
The term “database” refers to one or more data storage structures, such as relational databases, NoSQL databases, or other persistent storage systems, configured to store, index, and enable retrieval of prompts, responses, and associated interaction records.
The term “refer to the stored database” refers to accessing data stored in the database, for example by querying, searching, or retrieving records, in order to obtain information such as past inquiries and responses that are relevant to a newly received inquiry.
The term “past inquiry similar to the received inquiry” refers to an inquiry previously stored in the database whose content exhibits similarity to the newly received inquiry, as determined by a similarity measure based on techniques such as keyword matching, semantic analysis, vector similarity, or other comparison methods.
The term “solution” refers to an answer, guidance, recommended action, or other output provided by the system that is intended to resolve, mitigate, or address the issue or request expressed in the user's inquiry.
The term “natural language processing technology” refers to algorithms, models, and techniques for processing, understanding, and analyzing human language expressed in text or speech, including but not limited to tokenization, part-of-speech tagging, sentiment analysis, emotion recognition, and semantic analysis.
The term “emotional state of the user” refers to at least one aspect of the user's affective or psychological condition, such as anger, frustration, anxiety, calmness, happiness, or sadness, as inferred from the content and characteristics of the user's inquiry and related contextual information.
The term “analyze an emotional state of the user” refers to applying natural language processing technology or related techniques to the inquiry and possibly additional context to infer the user's emotional state, for example by detecting sentiment, intensity, and type of emotion.
The term “generate the response based on a result of the analysis of the emotional state” refers to modifying or adapting at least part of the content, tone, style, or structure of the response in accordance with the inferred emotional state of the user, so as to produce a response that is appropriate for the user's psychological condition.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

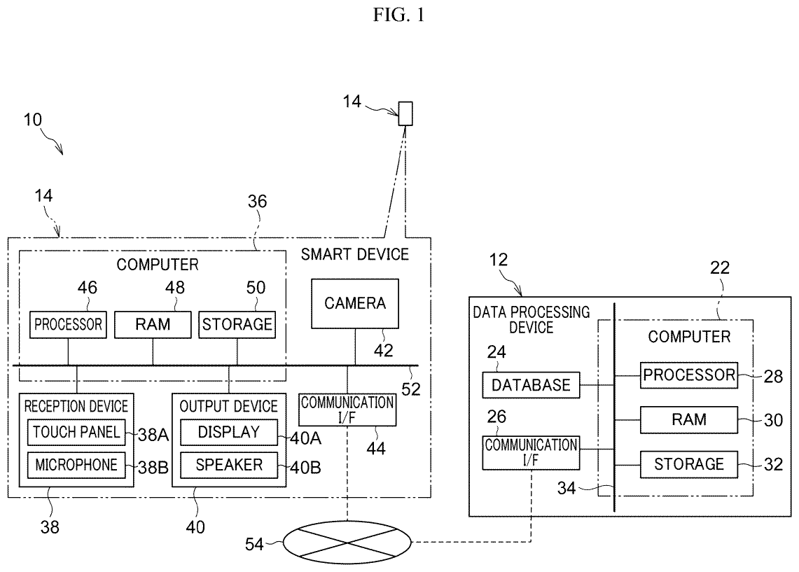

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

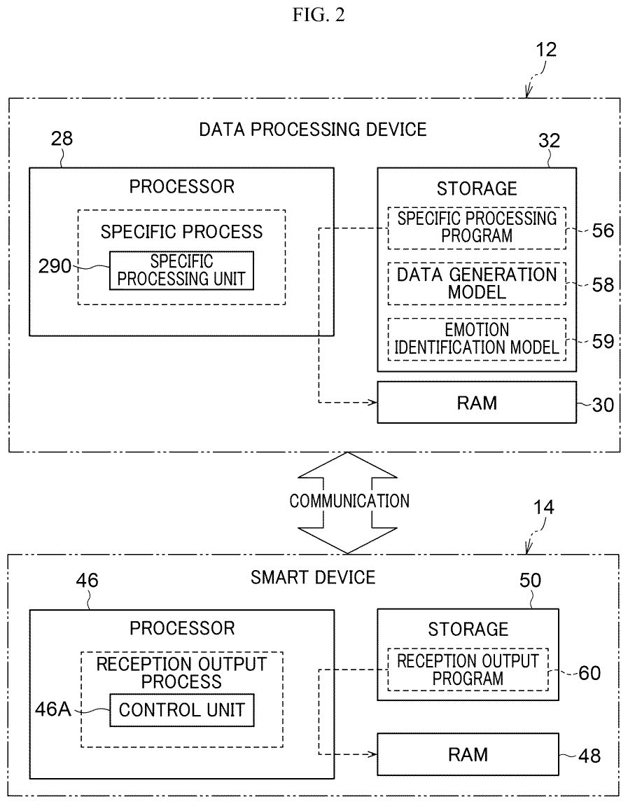

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information provision systems using a generative AI model typically process each prompt sentence from a user in isolation. In many cases, a server receives a prompt sentence, forwards the prompt sentence directly to a generative AI model, and returns the raw output as a response, without effectively reusing past interactions or evaluating whether the generated output is reliable, timely, or appropriate for the user's context. As a result, such systems suffer from increased computational load, higher latency, and inconsistent answer quality, particularly when many users repeatedly submit similar or identical inquiries.

Furthermore, in typical architectures, storage of past prompt sentences and responses, if implemented at all, is usually performed in a simple log format, without structured indexing or similarity search mechanisms. This makes it difficult for a processor to efficiently retrieve a past response that is semantically similar to a new inquiry.

Consequently, the system repeatedly invokes the generative AI model for queries that could be resolved using existing data, thereby wasting network bandwidth and computing resources and degrading overall throughput.

In addition, existing systems generally lack a robust mechanism to determine when an inquiry should be escalated from an automatic response engine to a human expert. There is often no integrated rule set or decision model that evaluates both the content of the prompt sentence and the generated response text to classify the inquiry as suitable for automated handling or requiring expert intervention. This can lead to inappropriate reliance on automated responses for high-risk or domain-critical inquiries, or conversely, excessive and unnecessary escalation of simple inquiries to human experts, both of which reduce system reliability and operational efficiency.

Moreover, typical systems do not sufficiently utilize natural language processing techniques to analyze user sentiment associated with the inquiry and the response. Without sentiment-aware control, the system cannot adapt the style, tone, or content of responses based on the emotional state of the user, which can result in user dissatisfaction and reduced effectiveness of support. From a computer-technology perspective, there is no unified control flow that coordinates similarity-based retrieval, generative AI invocation, expert escalation, and sentiment-aware response generation within a single processor-controlled pipeline.

Accordingly, there is a need for an improved computer-implemented system and server architecture that: (i) efficiently reuses past interactions by performing structured similarity search over stored prompt sentences and response texts; (ii) selectively invokes a generative AI model only when reuse is not suitable or a past response is invalid; (iii) automatically determines, based on predefined rules or decision models, when an inquiry should be escalated to a human expert; and (iv) dynamically adapts the response content and style based on sentiment analysis. Such an architecture should improve computational efficiency, reduce response time, enhance answer quality, and provide a more robust and controllable interaction flow from the standpoint of computer technology.

The specific processing by the specific processing unit 290 of the data processing device 12 in Example 1 is realized by the following means.

The present invention provides a server comprising a processor and a storage device, wherein the processor is configured to receive, via a communication interface, a prompt sentence transmitted from a user through an information processing apparatus, parse the prompt sentence as text data to extract inquiry content, search, based on the inquiry content, the storage device in which inquiry history and response history are stored, determine similarity between the prompt sentence and past prompt sentences by using at least one of a text similarity calculation function and a hash comparison function, and, when a past prompt sentence satisfying a predetermined condition exists, acquire response text associated with the past prompt sentence, generate model input data for inputting the prompt sentence into a generative AI model when the past prompt sentence satisfying the predetermined condition does not exist or when the acquired response text is determined to be invalid, transmit the model input data to the generative AI model operating on computing resources, and receive model output data including response text from the generative AI model, execute, on at least one of the acquired response text and the response text received from the generative AI model, at least one process selected from a group consisting of text normalization processing, prohibited expression removal processing, safety determination processing, and display format conversion processing, to generate a response message to be presented to the user, register, update, and index, in the storage device by using a database management function, the prompt sentence, the inquiry content, the response text, and metadata related to the response message, determine, based on at least one of the inquiry content and the response text, whether the inquiry is difficult to resolve by automatic response alone by using a predefined rule set or a determination model, and, when it is determined that the inquiry is difficult to resolve, register task information in an expert management apparatus that stores expert management information classified by field and associate the task information with the prompt sentence and the response text to perform escalation to an expert, and further execute sentiment analysis processing using natural language processing technology on at least one of the inquiry content and the response text to dynamically control at least one of input content to the generative AI model, conditions for escalation to the expert, and a style and an expression of the response message, and transmit, via the communication interface, at least one of the response message and a status message indicating an escalation state to the information processing apparatus of the user. This enables an integrated computer-implemented control flow that reduces unnecessary calls to the generative AI model, accelerates response generation by reusing stored interactions through similarity search, improves reliability by automatically escalating appropriate inquiries to human experts, and enhances user interaction quality by dynamically adapting responses based on sentiment analysis, thereby improving the overall performance and technical operation of the server system.
The term “server” refers to a computing apparatus including at least one processor and at least one storage device, configured to communicate with one or more information processing apparatuses over a communication network and to execute programs that implement the functions described herein.
The term “processor” refers to a hardware processing unit, such as a central processing unit or a programmable processing core, capable of executing machine-readable instructions to perform logical operations, arithmetic operations, data transfer operations, and control operations.
The term “storage device” refers to a non-transitory computer-readable medium, such as a semiconductor memory, magnetic storage, or optical storage, configured to store programs, configuration data, prompt sentences, inquiry history, response history, and metadata used by the processor.
The term “communication interface” refers to a hardware and software component that enables data communication between the server and external devices over a wired or wireless communication network, using one or more communication protocols.
The term “information processing apparatus” refers to a user-operated device, such as a terminal, a client device, or a computing device, equipped with an input interface, an output interface, and a communication function, and configured to transmit prompt sentences to the server and receive response messages from the server.
The term “user” refers to a human operator or an entity that interacts with the server through an information processing apparatus by providing prompt sentences and receiving response messages.
The term “prompt sentence” refers to text data representing an inquiry, request, or instruction provided by a user to the server and intended to be processed by a generative AI model or by similarity-based retrieval in the server.
The term “inquiry content” refers to semantic information extracted from a prompt sentence, including at least a representation of the subject, intent, and constraints of the user's inquiry as interpreted by the processor.
The term “inquiry history” refers to structured data stored in the storage device that includes previously received prompt sentences and associated inquiry content, timestamps, user identifiers, and related metadata.
The term “response history” refers to structured data stored in the storage device that includes response texts generated or selected by the server, together with corresponding prompt sentences, inquiry content, timestamps, and related metadata.
The term “response text” refers to text data representing an answer, explanation, or solution generated by a generative AI model or retrieved from the storage device in association with a past prompt sentence.
The term “response message” refers to output data prepared for presentation to a user, including at least response text and optionally including formatting information, annotations, disclaimers, or status indicators.
The term “metadata” refers to auxiliary data associated with a prompt sentence, inquiry content, response text, or response message, including, for example, timestamps, identifiers, classification labels, similarity scores, and escalation flags.
The term “generative AI model” refers to a machine learning model configured to generate text data in response to input data, using probabilistic or neural network-based techniques, including but not limited to models trained for natural language generation.
The term “model input data” refers to structured data generated by the processor from a prompt sentence and optionally from context information, and provided as input to a generative AI model in a format required by that model.
The term “model output data” refers to structured data returned by a generative AI model, including at least response text and optionally including additional information such as probabilities, tokens, or intermediate representations.
The term “text similarity calculation function” refers to a computational procedure or algorithm executed by the processor to compute a measure of similarity or distance between two or more text strings, based on features such as lexical overlap, semantic vectors, or statistical properties.
The term “hash comparison function” refers to a computational procedure executed by the processor to generate compact hash values from text strings and to compare the hash values in order to identify identical or highly similar prompt sentences.
The term “text normalization processing” refers to operations performed on text data to standardize its representation, such as converting character case, removing extraneous whitespace, normalizing punctuation, or applying tokenization.
The term “prohibited expression removal processing” refers to operations performed on text data to detect and remove or replace words, phrases, or patterns that are predefined as disallowed, inappropriate, or unsafe.
The term “safety determination processing” refers to operations, including rule-based checks or model-based evaluation, for determining whether content in a prompt sentence or response text complies with predetermined safety, compliance, or content policies.
The term “display format conversion processing” refers to operations that convert raw text data into a format suitable for presentation on an information processing apparatus, such as converting plain text to markup, adding line breaks, or adjusting layout-related notation.
The term “database management function” refers to software and supporting mechanisms executed by the processor to store, retrieve, update, and index data in the storage device, according to a defined data model and access methods.
The term “predefined rule set” refers to a collection of explicitly specified logical conditions, thresholds, and actions that the processor uses to classify inquiries, determine escalation, or select processing paths.
The term “determination model” refers to a computational model, including but not limited to a machine learning model or heuristic model, used by the processor to evaluate input data and output a decision or score used for classification or control.
The term “expert management apparatus” refers to a system or component configured to manage information on human experts, including their fields of expertise, availability, identifiers, and associated tasks, and to register or update task information for those experts.
The term “task information” refers to structured data representing a unit of work for an expert, including at least a reference to the original prompt sentence, the associated response text, classification information, and status information.
The term “expert” refers to a human operator or organization having specialized knowledge or qualifications in a particular domain, to whom inquiries can be escalated when automatic response is insufficient.
The term “escalation” refers to a process in which an inquiry handled initially by automatic processing is transferred or assigned, in whole or in part, to an expert, together with associated data such as the prompt sentence and response text.
The term “status message” refers to text data or structured data indicating a processing state or escalation state of an inquiry, such as whether a response is generated by automatic processing, pending expert review, or completed by an expert.
The term “text embedding vector” refers to a numerical vector representation of a text string, generated by a model or algorithm such that semantic or contextual similarity between text strings corresponds to a distance or similarity measure between their vectors.
The term “vector search” refers to a retrieval process in which similarity between text embedding vectors is computed, using a metric such as cosine similarity or Euclidean distance, to identify stored items that are similar to a query item.
The term “similarity” refers to a quantitative or qualitative measure representing how closely two or more items, such as prompt sentences or their embedding vectors, resemble each other according to a defined metric.
The term “sentiment analysis processing” refers to natural language processing operations executed by the processor to estimate an emotional or attitudinal state expressed in text, such as positivity, negativity, urgency, or frustration.
The term “style and expression of the response message” refers to characteristics of language used in a response message, including tone, formality level, politeness, level of detail, and choice of wording, which can be adjusted based on sentiment or other factors.
The term “automatic response” refers to a response that is generated or selected by the server without direct intervention by an expert, using similarity search, a generative AI model, rule-based processing, or combinations thereof.
The term “computing resources” refers to hardware and software resources, including processing units, memory, and network interfaces, that execute or host a generative AI model or other computational functions used by the server.

In one embodiment, a server implements the claimed system by executing a program on one or more processors and by cooperating with one or more terminals operated by users. The server includes a central processing unit, a main memory, a non-transitory storage device such as a solid-state drive, a network interface controller, and an operating system such as a general-purpose server operating system. The server further executes middleware software such as a web server, an application framework, a database management system, and an interface library for communicating with a generative AI model. The terminal includes a processor, a memory, a display, an input interface such as a keyboard or touch panel, and a communication interface for connecting to the server via a network such as the Internet.

The user operates the terminal to start a web browser or a dedicated client application. The terminal displays an input field for a prompt sentence and a display area for a response message. The user inputs a prompt sentence as natural language text, for example, “Tell me today's top three technology news stories.” or “What will the weather be like tomorrow in Tokyo?” or “Please review this legal contract and tell me the risks.” The terminal converts the input into text data and transmits the text data to the server through the communication interface using a request protocol such as HTTP over TLS.

The server receives the prompt sentence through the network interface controller and forwards the received data to the application framework. The server parses the incoming data according to a predefined data structure, and stores the prompt sentence as a Unicode string in the main memory. The server normalizes the string by lowercasing characters, removing redundant whitespace, and converting character encodings to a standard internal representation, thereby facilitating subsequent similarity calculations and database indexing. The server further extracts inquiry content, for example, by applying a natural language processing module based on tokenization, part-of-speech tagging, and syntactic parsing, implemented in software libraries suitable for the chosen programming environment.

The server stores prompt sentences, inquiry content, and response texts in the storage device by using a relational database management system such as a general-purpose SQL database. The server defines tables for prompts, responses, and expert tasks, in which each record is assigned a primary key. The server stores, for each prompt sentence, fields such as a prompt identifier, a user identifier, a normalized prompt string, a timestamp indicating when the prompt was received, and optional classification labels. The server stores, for each response text, fields such as a response identifier, a prompt identifier, the response text, a timestamp indicating when the response was generated, a model identifier indicating the generative AI model used, and an indicator whether the response originated from reuse of a past response or from a newly generated output.

The server calculates numerical representations of text, referred to as text embedding vectors, for prompt sentences and optionally for response texts. In one implementation, the server uses a generative AI model or a specialized embedding model that implements a deep neural network with multiple layers, such as a transformer-based architecture. The server inputs tokenized text to the embedding model, where each token is mapped to a dense vector representation, and self-attention layers compute contextualized embeddings.

The server obtains a fixed-length vector for each prompt sentence by applying a pooling operation such as averaging or selecting a special token output. The server stores these embedding vectors in the storage device in association with their corresponding prompt identifiers and may maintain a vector index structure.

The server searches for past prompt sentences similar to a newly received prompt sentence by comparing text embedding vectors. The server retrieves embedding vectors from the storage device into memory and computes similarity scores between vectors by using metrics such as cosine similarity. In some embodiments, the server uses a vector index such as a tree structure or an approximate nearest neighbor structure to accelerate retrieval. Because the server operates directly on numeric vectors in high-dimensional space, the server can detect semantic similarity beyond simple keyword overlap, thereby enabling reuse of past responses for paraphrased queries. This structured similarity search reduces the need to repeatedly send similar prompts to a generative AI model, which decreases computational load and network usage.

The server determines whether a past response is valid for reuse based on conditions such as the similarity score between prompt sentences, the timestamp difference between the past interaction and the current time, and domain-specific rules. For example, when the inquiry content relates to time-sensitive information such as weather or financial data, the server restricts reuse to responses generated within a short time window. The server may define threshold values for similarity scores and time windows, and the server compares calculated values with these thresholds. By applying such rule-based evaluation in addition to similarity search, the server ensures that reused responses maintain a required level of freshness and accuracy, improving technical reliability.

When the server decides that reuse is not appropriate or when no sufficiently similar past prompt exists, the server constructs model input data for a generative AI model. In one embodiment, the server uses a transformer-based generative AI model with multiple attention layers, feed-forward layers, and positional encoding mechanisms. The server tokenizes the prompt sentence, converts tokens into numerical indices, and packs these indices into a sequence that is input to the generative AI model. The generative AI model has been trained beforehand on large-scale text corpora using supervised or self-supervised learning, where the training procedure includes defining a loss function, such as cross-entropy between predicted token distributions and target tokens, and updating model parameters by an optimization algorithm such as stochastic gradient descent with adaptive learning rate methods. The server accesses this model either as an external service via an application programming interface or as a locally deployed model running on dedicated computation hardware such as graphical processing units or tensor processing units.

The server transmits the model input data to the generative AI model and receives model output data containing predicted token sequences. The generative AI model computes its output by executing multiple matrix multiplications and non-linear activation functions across its neural network layers. The self-attention mechanism calculates attention weights between all pairs of tokens in the input sequence, and these weights influence how context is aggregated. The model outputs a probability distribution over the vocabulary for each token position, and a decoding strategy such as greedy decoding or sampling selects the most likely or appropriate tokens. The model output data is transmitted back to the server as a sequence of token identifiers or text segments.

The server decodes the token identifiers into a response text string and applies text normalization processing such as removal of trailing whitespace, unification of punctuation, and conversion of control characters. The server also performs prohibited expression removal processing by scanning the response text for words or patterns that match entries in a preconfigured list or that violate predetermined rules. The server can apply a safety determination processing module that uses a classification algorithm, which may be a separate neural network or a rule-based engine, to detect unsafe, offensive, or policy-violating content. When such content is detected, the server replaces or masks offending portions or generates an alternative safe message according to predefined guidelines.

The server formats the response text as a response message suitable for presentation on the terminal. The server may convert line breaks and lists into markup elements, attach metadata indicating how the terminal should display emphasis or structure, and generate additional labels indicating whether the response was generated by reuse of past data, by a generative AI model, or by a human expert. The server then stores the generated response text, the associated prompt sentence, the embedding vectors, and relevant metadata in the storage device by executing database insert operations. The server may also update an index on normalized prompt text and embedding vectors to facilitate faster retrieval in subsequent operations.

The server determines whether to escalate an inquiry to an expert by applying a predefined rule set or a determination model. The server considers features such as keywords in the inquiry content, classification labels assigned by a topic classifier, risk categories, and the safety determination result. For example, the server may have rules that queries involving legal rights, medical diagnoses, or financial investment decisions must be escalated when certain risk indicators are present. Alternatively, the server may use a machine learning-based determination model trained on past escalation decisions, where input features include embedding vectors, sentiment scores, and generated response confidence scores. The server computes an escalation score and compares the score against a threshold, and when the threshold is exceeded, the server registers task information in an expert management system and associates the task with the corresponding prompt sentence and response text.

The server executes sentiment analysis on the inquiry content and, optionally, on the response text. In one embodiment, the server uses a neural network-based sentiment classifier trained to output sentiment categories such as positive, neutral, or negative, and intensity scores such as frustration or urgency. The classifier may use a convolutional neural network or a transformer architecture, where the server feeds tokenized text and receives probability scores for sentiment labels. The server then uses these scores to adjust the style and expression of the response message, for example by choosing more empathetic language when negative sentiment is detected or by increasing the level of detail when confusion is inferred. This dynamic modification of output parameters affects how the generative AI model is invoked, such as by adjusting temperature or prompt context, and how text is post-processed.

The server improves computer technology by coordinating these functions in a unified control flow that reduces redundant computation and network calls. Because the server uses similarity search over embedding vectors and hashes, the server can often avoid invoking the generative AI model, which is computationally expensive. This directly reduces processor usage, memory access, and network bandwidth consumption. The structured storage of prompt sentences and embedding vectors, combined with indexing, lowers database query time and improves cache hit rates. By applying rule-based and model-based validity checks before reusing a response, the server limits erroneous reuse and thereby reduces the need for repeated correction cycles. The expert escalation mechanism further ensures that complex or high-risk inquiries are handled with appropriate human intervention without requiring manual triage by human operators at the outset, thus enhancing throughput of the server system as a whole.

The terminal receives the response message from the server and updates the display. The terminal may render a chat-like conversation view where the user's prompt sentence and the server's response message appear as separate bubbles. The terminal can also indicate whether the response originated from automatic processing or from an expert. When the server indicates that escalation is pending, the terminal displays a status message such as “A human expert is reviewing your inquiry.” As further expert responses are generated and stored by the server, the terminal can fetch and display the updated results.

In a variation of the embodiment, the server employs different embedding models for different domains, for example one model specialized for legal text and another for technical support queries. The server selects an appropriate embedding model based on an initial classification of the prompt sentence. In another variation, the server deploys the generative AI model locally on accelerated hardware, such as a cluster of graphical processing units, to reduce latency and dependence on external network connections. In yet another variation, the server partitions the storage device into multiple shards, each indexed by hash ranges or vector subspaces, and distributes similarity search across these shards to improve scalability.

The server can also adapt the parameters of its similarity search and escalation thresholds based on system load and historical performance. When the system is under heavy load, the server may increase the reuse of past responses by relaxing similarity thresholds and decreasing the number of calls to the generative AI model to maintain low response times. When higher accuracy is required, the server may tighten thresholds and prioritize fresh generation. Because such adjustments are implemented in system-level control logic and not merely in human procedures, the invention realizes a technical effect in terms of dynamic resource management and quality control within the computing infrastructure.

Through these embodiments and variations, the server, the terminal, and the user cooperate in a system that not only automates response generation but also structurally improves the efficiency, stability, and adaptability of the underlying computer processes.

The combination of embedding-based similarity search, rule-and model-based decision logic, expert escalation management, and sentiment-aware output control provides a non-conventional, technical solution that enhances performance and functionality of the server beyond a mere implementation of human judgment on a generic computer.

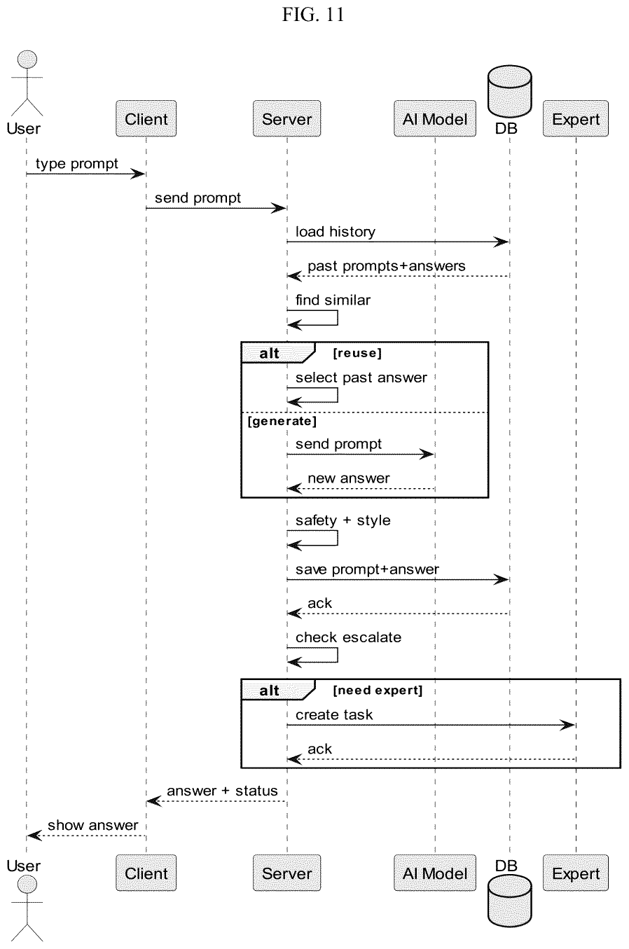

The following describes the processing flow using FIG. 11.

### Step 1:

User operates the terminal to input a prompt sentence. User views an input field on the terminal's display, provided by a web browser or a client application, and types a natural-language prompt sentence such as “Tell me today's top three technology news stories.” or “What will the weather be like tomorrow in Tokyo?” or “Please review this legal contract and tell me the risks.”
Input: Keystrokes or touch input from the user.
Processing: Terminal converts the user's physical input events into a Unicode text string, applies basic client-side validation (for example, checking that the string is not empty), and associates the string with a session identifier.
Output: A structured request payload in the terminal's memory, including at least the prompt sentence text and session information, ready to be sent to the server.

### Step 2:

Terminal transmits the prompt sentence to the server. Terminal constructs an HTTP request addressed to the server's API endpoint, sets headers such as Content-Type and authorization information, and embeds the prompt sentence and optional metadata (for example, language code, time zone, client version) in the request body.
Input: The prompt sentence string and associated metadata from Step 1.
Processing: Terminal serializes the data into a format such as JSON, opens a secure network connection using a protocol such as TLS, and writes the serialized bytes to the network socket under control of the operating system's network stack.
Output: An encrypted network packet stream containing the prompt sentence, transmitted to the server over a communication network.

### Step 3:

Server receives and parses the incoming request. Server accepts the network connection through a network interface controller, terminates the TLS session, and passes the decrypted HTTP request to an application framework.
Input: The HTTP request bytes containing the serialized prompt sentence received from the terminal.
Processing: Server reconstructs the HTTP message, parses the headers and body, decodes the JSON or equivalent structure, and converts the encoded text into an internal Unicode string representation stored in main memory. Server also extracts or derives a user identifier, a session identifier, and a timestamp indicating when the request was received.
Output: An internal data structure in memory that includes the prompt sentence text, user-related information, and request metadata.

### Step 4:

Server normalizes and analyzes the prompt sentence. Server prepares the text for downstream processing by applying normalization rules and language analysis.
Input: The raw prompt sentence text and metadata from Step 3.
Processing: Server converts all characters to a standard case (for example, lower case), removes redundant whitespace, normalizes punctuation, and optionally performs language detection. Server then applies a natural language processing module to segment the text into tokens, assign part-of-speech tags, and optionally identify named entities and domain-specific keywords. Server aggregates these results into a representation of inquiry content.
Output: A normalized prompt sentence string and an inquiry content structure containing tokens, linguistic annotations, and extracted features.

### Step 5:

Server computes or retrieves a text embedding vector for the prompt sentence. Server maps the normalized text into a numeric vector space to enable similarity search.
Input: The normalized prompt sentence string from Step 4.
Processing: Server either calls an embedding model (for example, a transformer-based encoder) or a locally deployed neural network. Server converts the tokens into token IDs, feeds them through multiple neural network layers including self-attention and feed-forward blocks, and obtains a contextual representation for each token. Server then applies a pooling operation, such as averaging all token vectors or selecting a designated token's vector, to produce a single fixed-length embedding vector.
Output: A numerical embedding vector associated with the current prompt sentence, stored in memory along with its prompt identifier.

### Step 6:

Server searches the storage device for similar past prompt sentences. Server performs similarity search using stored embeddings and possibly hash values.

Input: The embedding vector from Step 5 and the normalized prompt string from Step 4.
Processing: Server queries the database for candidate records by applying an index on normalized prompt text or prompt hash and retrieves corresponding embedding vectors. Server then computes similarity scores between the current embedding vector and stored vectors using a metric such as cosine similarity. Server may also compare hash values for exact or near-exact matches. Server ranks the candidate past prompts by similarity score and selects top candidates that exceed a predetermined threshold.
Output: A set of candidate past prompt records, each including a past prompt identifier, its embedding vector, similarity score, and associated response text, or an indication that no suitable past prompt exists.

### Step 7:

Server decides whether to reuse a past response or to generate a new one. Server evaluates validity of candidate past responses based on similarity and temporal conditions.
Input: The set of candidate past prompt records from Step 6 and the current timestamp.
Processing: Server checks whether the highest similarity score exceeds a reuse threshold and verifies additional conditions such as maximum allowable age of the past response for time-sensitive domains. Server applies rule-based logic that may consider domain labels, risk categories, and user-specific settings. Server sets an internal flag indicating reuse when all conditions are satisfied; otherwise, the server decides to call the generative AI model.
Output: A decision state indicating “reuse past response” or “invoke generative AI model,” and, in the reuse case, a selected past response text.

### Step 8:

Server generates model input data and calls the generative AI model when reuse is not selected. Server prepares a prompt structure suitable for the generative AI model's API or local interface.
Input: The normalized prompt sentence, inquiry content, and decision state from Step 7 indicating that a new response is required.
Processing: Server tokenizes the prompt sentence according to the generative AI model's vocabulary, constructs a sequence of token IDs, and packages them along with control parameters such as maximum output length, temperature, and top-k or top-p settings. Server then transmits this model input data to a generative AI model running either as an external service or as a local model on specialized hardware. The generative AI model processes the token sequence through multiple layers of its neural network to compute output token distributions. Server receives the model output data, which includes generated token sequences or text fragments.
Output: A raw generated response text decoded from the model output data, stored in the server's memory.

### Step 9:

Server post-processes the selected or generated response text. Server refines the output for safety, quality, and display.
Input: Either the reused past response text from Step 7 or the newly generated response text from Step 8.
Processing: Server normalizes whitespace and punctuation, and then scans the text against a list of prohibited terms or patterns. Server removes or replaces prohibited content and may apply an additional classification model or rule set to determine whether the response complies with safety and policy standards. Server optionally adjusts formatting, inserts headings or bullet points, and attaches metadata indicating the source of the response (reused, generated, or combined).
Output: A cleaned and formatted response text that satisfies safety and formatting requirements.

### Step 10:

Server performs sentiment analysis and adjusts the response message style. Server tailors the tone and structure of the response based on inferred sentiment.
Input: The inquiry content from Step 4 and the cleaned response text from Step 9.
Processing: Server inputs one or both texts into a sentiment classifier, which may be a neural network trained to output sentiment categories and intensity scores. Server obtains sentiment scores such as “negative,” “frustrated,” or “urgent.” Based on these scores, server modifies aspects of the response text, for example, by selecting more empathetic phrasing, increasing the level of explanation, or adding clarifying examples. Server may also adjust parameters for future model calls (for example, more detailed prompts for confused users).
Output: A sentiment-adjusted response message text and updated control parameters for subsequent interactions.

### Step 11:

Server stores the interaction data in the storage device. Server records the prompt sentence, response message, and derived data for future reuse and analysis.
Input: The normalized prompt sentence, inquiry content, embedding vector, response message text, and associated metadata such as timestamps, model identifiers, similarity scores, and sentiment scores.
Processing: Server constructs database records linking the prompt, embedding vector, and response. Server executes insert or update operations on the database, updating indexes on normalized prompt strings, hashes, and embedding vectors. Server ensures that the transaction is committed so that data is durably stored on a non-transitory storage device.
Output: Persisted database records that represent the interaction history, available for future similarity searches and system analytics.

### Step 12:

Server determines whether expert escalation is required and, if so, registers a task. Server evaluates whether the inquiry should be handled by a human expert.
Input: The inquiry content, response message, safety determination result, and sentiment scores from previous steps.
Processing: Server applies a predefined rule set or a determination model that considers domain-specific keywords, risk indicators, and classification labels. Server computes an escalation score and compares it to a threshold. If escalation is required, server prepares task information containing the prompt sentence, the generated or reused response, classification tags, and user contact or session data. Server then sends this task information to an expert management system and stores the task identifier in the database.
Output: Either a status flag indicating “no escalation required,” or a newly created expert task record with a corresponding identifier and an updated status for the interaction.

### Step 13:

Server constructs and transmits the final response to the terminal. Server encapsulates the response message and status information into a network response.
Input: The sentiment-adjusted response message from Step 10 and the escalation status from Step 12.
Processing: Server builds a structured response payload that includes at least the response message text and fields indicating whether the answer was reused, newly generated, or escalated to an expert. Server serializes this payload, sets appropriate protocol headers, and sends the data as an HTTP response over a secure channel to the terminal.
Output: A network response containing the response message and status information, delivered to the terminal.

### Step 14:

Terminal receives and displays the response message to the user. Terminal updates the user interface based on the server's response.
Input: The structured response payload received from the server in Step 13.
Processing: Terminal parses the payload, extracts the response message text and status flags, and renders them on the display in a designated area. Terminal may display additional indicators such as “AI-generated response,” “Answer retrieved from past interactions,” or “Escalated to human expert.” Terminal may also log the interaction locally for quick navigation within the session.
Output: A visual presentation of the response message on the terminal's display, perceivable by the user, along with any status indicators.

### Step 15:

User reads the response and optionally provides a follow-up prompt sentence. User interacts with the system in an iterative manner.
Input: The displayed response message and status indication shown by the terminal in Step 14.
Processing: User interprets the content, decides whether additional clarification or a new inquiry is needed, and, if so, inputs another prompt sentence such as “Explain in more detail” or “Give me an example.” The new prompt is again converted into text by the terminal.
Output: A new prompt sentence input that can be processed by repeating Steps 1 through 14 in a subsequent interaction cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information provision systems using generative AI models typically process each user inquiry in isolation, without effectively leveraging accumulated user-specific interaction history. In many deployments, a server receives natural-language inquiries from user terminals and forwards them to a generative AI model with a generic prompt sentence that does not systematically reflect the user's past inquiries, past responses, or long-term preferences. As a result, the generated responses tend to be generic, inconsistent across sessions, and insufficiently tailored to the user's preferences, leading to reduced usefulness and user satisfaction.

Furthermore, in existing architectures, interaction history, if stored at all, is often recorded in an unstructured or weakly structured manner that is not directly exploitable by the generative AI model at inference time. The server may log raw text conversations in a database, but the processing logic does not extract intent information, attribute information, or preference information in a structured form. Consequently, the server is unable to perform efficient retrieval of semantically relevant past interactions or to construct optimized prompt sentences that focus the generative AI model on context that is most likely to improve answer quality and relevance.

In addition, some systems attempt to incorporate history by simply appending large amounts of prior conversation text to every prompt, which leads to excessive prompt length, higher computational cost, and degraded response latency. Such naive inclusion of history also risks including irrelevant or contradictory context, which can confuse the generative AI model and degrade answer accuracy. This behavior runs counter to the goal of improving computer technology, because it increases processing load on networked AI services and databases without a commensurate gain in output quality.

There is therefore a need for a computer-implemented system that improves the way a server preprocesses user inquiries and history data before invoking a generative AI model. Specifically, there is a need for a system in which a processor automatically (i) extracts intent information and attribute information from current inquiries, (ii) retrieves and structures relevant past inquiry and response history from an information storage device, (iii) generates or updates a user profile representing user preference information, and (iv) constructs a compact, context-optimized prompt sentence for the generative AI model. By integrating these functions, the system can improve the technical performance of the underlying computing environment, including response accuracy, response latency, and resource efficiency.

Moreover, there is a need for a mechanism by which the processor selectively summarizes and injects only semantically relevant portions of the history information into the prompt sentence, such that the generative AI model operates on a denser, higher-quality context. This selective inclusion should be based on semantic similarity and structured preference data, not merely on chronological order or raw text length, thereby reducing unnecessary data transfer and processing overhead. Such an approach improves the operation of the computer system itself by optimizing database access patterns, reducing payload sizes between the server and the generative AI model, and enhancing the effectiveness of natural-language response generation.

Accordingly, an objective of the present invention is to provide a system that technically improves computer-based information provision by configuring a processor to transform raw interaction logs into structured user profile information and context-aware prompt sentences. This improves the internal data handling pipeline of the server, leading to higher-quality and more personalized responses, faster answer generation, and more efficient utilization of storage, network, and processing resources.

The specific processing by the specific processing unit 290 of the data processing device 12 in Application Example 1 is realized by the following means.

The present invention provides a server comprising a processor and an information storage device, the processor being configured to receive inquiry information expressed in natural language from a user terminal, extract intent information and attribute information from the inquiry information using natural-language processing, access a group of history information stored in the information storage device to retrieve past inquiry history information and response history information associated with user identification information, generate or update structured user profile information representing preference information of a user based on the retrieved history information, construct a prompt sentence to be input to a generative artificial intelligence model by including, in a compact textual form, current inquiry information, the user profile information, and selected past response history information, input the prompt sentence to the generative artificial intelligence model to cause the generative artificial intelligence model to generate response information, store the response information in association with the inquiry information and the user identification information in the information storage device, and transmit the response information to the user terminal in a format suitable for display. This enables the computer system to technically improve the generation of personalized and contextually appropriate responses by the generative AI model, while reducing unnecessary data transfer and processing, thereby enhancing response accuracy, reducing latency, and improving overall computational efficiency.
The term “system” refers to a combination of hardware and software components, including at least one processor and at least one information storage device, configured to execute the functions described in the claims.
The term “processor” refers to one or more hardware processing units, such as a central processing unit or other computing circuitry, capable of executing instructions to perform data processing operations as described in the claims.
The term “information storage device” refers to one or more non-transitory computer-readable storage media, such as a magnetic disk, a solid-state drive, or a memory device, configured to store data including history information, user profile information, and response information.
The term “user terminal” refers to an electronic device operated by a user, such as a personal computer, a mobile terminal, or another communication device, configured to transmit inquiry information to the server and receive response information for display.
The term “inquiry information” refers to data representing a request, question, or instruction expressed by a user in natural language and transmitted from the user terminal to the server.
The term “natural language” refers to a human language used for general communication, including written or spoken text, as opposed to a formal programming language.
The term “intent information” refers to data representing an inferred purpose or objective of the user's inquiry, such as a request for information, a request for a recommendation, or a request for an action.
The term “attribute information” refers to data representing characteristics associated with an inquiry or a user, such as content type, topic, constraints, user context, or other descriptive parameters extracted from the inquiry information.
The term “user identification information” refers to data that identifies or distinguishes a user, such as a user ID, account identifier, or other identification token used to associate inquiries and responses with a particular user.
The term “history information” refers to data representing past interactions between the user and the system, including past inquiry history information, response history information, timestamps, and associated metadata.
The term “inquiry history information” refers to a subset of the history information that includes records of past inquiry information transmitted by the user terminal and processed by the system.
The term “response history information” refers to a subset of the history information that includes records of past response information generated by the system or by the generative artificial intelligence model and provided to the user terminal.
The term “user profile information” refers to structured data representing characteristics of a user, including preference information, attribute information, and aggregated history information derived from past interactions.
The term “preference information” refers to data describing tendencies, likes, dislikes, or interests of a user, such as preferred content categories, topics, genres, or other selection criteria inferred or explicitly specified.
The term “prompt sentence” refers to text or message data constructed by the processor and provided as input to the generative artificial intelligence model, the text including at least the current inquiry information, user profile information, and selected history information.
The term “generative artificial intelligence model” refers to a machine-learned model, such as a neural network-based language model, configured to generate natural-language text or other output data in response to input data including a prompt sentence.
The term “response information” refers to data, including natural-language text or structured content, generated by the generative artificial intelligence model based on a prompt sentence and provided by the system as an answer or output corresponding to an inquiry.
The term “semantic similarity” refers to a measure indicating how closely the meanings of two pieces of text or data correspond to each other, as determined by a numerical or algorithmic comparison of their semantic features or embeddings.
The term “compact textual form” refers to a format in which information is represented using a reduced and summarized amount of text such that essential semantic content is preserved while length and redundancy are minimized.
The term “displayable format” refers to a data format suitable for presentation on a user terminal, including text, lists, or structured data that can be rendered by a graphical user interface or another output interface.

In an embodiment, a server implements the claimed system by executing a set of computer programs on one or more hardware processors and cooperating with one or more terminals operated by users. The server includes at least one central processing unit, a main memory, a network interface, and a non-transitory information storage device such as a magnetic disk or solid-state drive. The server executes an operating system such as a general-purpose server operating system, and an application framework such as a web application framework. The server further communicates with an external generative AI model service via a network, and stores history information and user profile information in a database management system.

The terminal includes a processor, a display device, an input device, a communication interface, and a local memory. The terminal executes a web browser or a native application that presents a graphical user interface to the user. The user operates the terminal to input inquiries expressed in natural language, to view response information, and to provide optional feedback. The terminal converts the user's input into request data, transmits the request data to the server via a network, and renders data received from the server in a displayable format.

The server uses specific hardware and software components to implement the data processing described in the claims. The server uses a database management system, such as a relational database system, to store and manage history information, user identification information, user profile information, and response information. The server uses a natural language processing library, such as a tokenization and embedding library, to extract intent information and attribute information from inquiry information. The server uses an external or internal generative AI model, implemented as a neural network-based language model, to generate response information based on a constructed prompt sentence.

The server stores history information in the database in structured data records. Each record includes at least a user identification field, an inquiry text field, a response text field, timestamps, and metadata fields. The server stores user profile information in a separate data structure, which may be a relational table or a key-value store, and which includes fields representing preference information such as favored categories, topics, and other attributes inferred from accumulated history information.

The server performs data processing in a modular architecture. The server uses a preprocessing module to normalize input text, a profile management module to generate and update user profile information, a selection and summarization module to choose relevant history information, and a prompt construction module to assemble a compact prompt sentence to be input to the generative AI model. The server uses a communication module to send the prompt sentence to the generative AI model and receive generated output, and a storage module to write updated history information to the database.

The server uses the natural language processing library to apply tokenization, part-of-speech tagging, and named entity recognition to the user's inquiry. The server further uses an embedding model, such as a sentence embedding model, to convert inquiry information and past history text into numerical vectors. The server compares these vectors using a similarity metric, such as cosine similarity, to determine semantic similarity between the current inquiry and past history entries. The server uses a similarity threshold or ranking mechanism to select a plurality of inquiry history information items that are semantically close to the current inquiry. The server summarizes these selected items, for example by truncating or compressing text and by retaining key phrases or entities, to generate a compact representation of the past context.

The server generates user profile information by aggregating features derived from multiple history records. The server may count occurrences of certain attributes, such as content categories or topics, and may compute preference scores using weighted averages or decay functions that assign higher weight to more recent interactions. The server stores, as user profile information, an explicit representation of these aggregated preferences, such as a list of preferred categories and associated scores. The server may update the user profile incrementally whenever new interactions occur, thereby adapting the profile over time.

The server constructs the prompt sentence in a structured manner. The server arranges the prompt sentence to include at least a role description, a history summary, a profile summary, and the current inquiry. For example, the server may form a prompt sentence such as:
“System: You are a recommendation assistant that uses the user's past viewing and query history to recommend suitable content. You respond concisely and clearly.
History: The user previously liked the science-fiction and action movies ‘Movie X’ and ‘Movie Y’. The user often asks for recent releases and avoids horror movies.
User profile: The user prefers science-fiction and action content, and tends to favor recent popular items.
Current query: Tell me some popular recent movies I might like.
Instruction: Based on the history and preferences above, suggest 3-5 recent popular movies that match the user's tastes. For each movie, provide a brief explanation of why it is a good match.”

The server transmits the constructed prompt sentence to the generative AI model. In an embodiment, the generative AI model is an autoregressive transformer-based neural network language model. The generative AI model includes multiple layers of self-attention and feed-forward networks, operates on tokenized input sequences, and has parameters (weights and biases) optimized through prior supervised and unsupervised training. The generative AI model receives the prompt sentence, encodes the tokens into embeddings, processes the embeddings through multiple transformer layers, and outputs probability distributions over possible next tokens. The generative AI model generates response information by iteratively selecting tokens according to a decoding strategy, such as greedy decoding or sampling with a temperature parameter, until an end condition is met.

The server may, in some embodiments, employ a fine-tuned version of a base generative AI model. In such embodiments, the server or a training environment uses training data that includes pairs of prompt sentences and desired responses to update the weights of the neural network via gradient-based optimization. The training process uses a loss function, such as cross-entropy loss between predicted and target tokens, and updates weights using an optimization algorithm, such as stochastic gradient descent or a variant thereof. The server thereby deploys a generative AI model that has been adapted to the target domain and style of responses. The server is thus able to generate response information with improved domain-specific accuracy.

The server uses a non-conventional combination of structured history retrieval, semantic similarity-based selection, and user profile-conditioned prompt construction. The server does not simply append entire unstructured histories to the prompt, but instead uses the embedding-based similarity measure and profile information to choose and compress only the most relevant entries. This selection and summarization procedure reduces the length of the prompt sentence, which in turn reduces the number of tokens processed by the generative AI model. As a result, the server reduces computational load on the generative AI model, decreases data transfer volume between the server and an external AI service, and improves response latency.

The server further improves accuracy and stability of responses by controlling the content and ordering of the prompt sentence. Because the server provides the generative AI model with a condensed, high-salience context, including explicit preference information and selected history summaries, the generative AI model is less likely to suffer from context dilution or contradictory information. The server thereby enhances the precision of generated responses, especially in recommendation scenarios.

The server applies structured rules and non-trivial algorithms that differ from mere human-style summarization or manual selection. The server uses machine-computed semantic similarity scores and profile-based constraints to select candidate history entries.

The server may apply constraints such as diversity (avoiding near-duplicate history entries), recency weighting, and domain-specific filters. These constraints and selection algorithms are implemented as discrete computation steps operating on vector representations of text, and thus constitute technological processing of data structures in the computer.

The server may, in some embodiments, adjust its prompt construction and selection criteria dynamically based on system performance metrics. For example, the server may monitor response latency and token usage statistics of the generative AI model. When latency or token usage exceeds predetermined thresholds, the server may reduce the number of history entries included in the prompt or increase the degree of summarization. Conversely, when available computational resources permit, the server may include more detailed history context to further improve accuracy. This feedback-controlled adaptation contributes to optimization of computational resource utilization in the system.

The server thereby effects a technical improvement in computer functionality. By transforming raw text logs and unsystematic history into structured user profile information and optimized prompt sentences, the server enables more efficient operation of the generative AI model. The resulting improvements include reduced network traffic between the server and the AI service, lower memory usage for context processing, and faster inference because the generative AI model processes shorter and more relevant input. These improvements are not merely automation of a human mental process; the system configures and coordinates multiple specialized computational modules, databases, and neural network inference engines in a non-conventional data flow that enhances the operation of the computing system itself.

The terminal, in cooperation with the server, also participates in technical improvements. The terminal can cache certain user interface states and reuse prior response information for local display without re-requesting identical information from the server. The terminal can adjust rendering based on structured response data, for example by selectively displaying recommended items, associated metadata, and explanation text. Such structured display, driven by the server's data structures, supports efficient user interaction and reduces redundant data transfers.

The user interacts with the system by issuing natural-language inquiries and optionally providing explicit feedback such as ratings or likes. The server uses such explicit feedback as additional signals in the user profile information. The server may update preference scores or modify weights in the profile aggregation function to reflect explicit user reactions. The server thus benefits from a combined use of implicit history (interaction records) and explicit feedback. This combined profiling yields more accurate preference models, further improving the selection of history entries and the construction of future prompt sentences, and thus closing a technical feedback loop.

In another embodiment, the server may operate with an on-premises generative AI model rather than an external service. In such a case, the server executes the neural network inference on local hardware accelerators such as graphics processing units or tensor processing units. The server manages model weights, loads model parameters into accelerator memory, and executes forward passes through the transformer architecture using optimized linear algebra libraries. The rest of the architecture, including history retrieval, profile generation, and prompt construction, remains as described. The technical effect of prompt optimization is even more pronounced in this embodiment, because the reduction of input tokens directly reduces computation time on local accelerators and energy consumption in the server.

In yet another embodiment, the server may use different types of generative AI models for different domains. For example, the server may route recommendation-type inquiries to one language model fine-tuned for recommendation tasks, and route explanatory or instructional inquiries to another model fine-tuned for explanations. The server may use intent information and attribute information extracted from the inquiry to select the appropriate generative AI model or model configuration. The server thus uses internal routing logic, based on computed intent and attributes, to improve suitability between input and model capabilities. This routing results in improved answer quality for each type of task and more efficient utilization of computational resources, because specialized models can be smaller or more optimized than a single universal model.

The server can further employ data augmentation techniques during training of the generative AI model. For instance, the server or a training subsystem may generate paraphrases of inquiries, perturbations of sentences, and simulated user profiles to broaden the training data. The learning process uses these augmented data to improve robustness of the model's internal representations. The server thereby deploys a generative AI model that generalizes well to a variety of prompt sentences constructed by the described system, including those that integrate profile and history information in various formats.

The server, by systematically configuring and using the generative AI model in connection with structured historical data and user profiles, goes beyond mere business process automation. The server implements specific data structures, such as user profile tables, embedding vectors, and prompt templates, and controls the flow of these structures through specialized modules. The combination of semantic embedding computation, profile-based selection, compact prompt construction, and adaptive resource management yields a concrete improvement in how the computer processes and stores data and how the generative AI model is invoked. This improvement is manifested as higher prediction accuracy for generated responses, reduced computational resource usage, and better responsiveness in interactive applications.

Through these embodiments and variations, the system provides a concrete implementation of the claimed invention that a person skilled in the art can realize using conventional server hardware, terminal devices, database systems, and generative AI models, while achieving the described technical effects and improvements in computer technology.

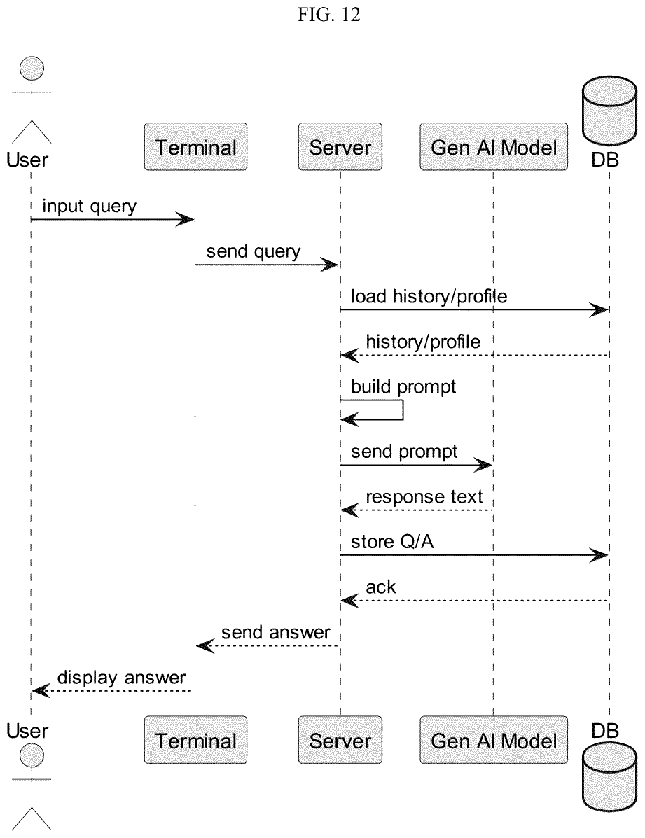

The following describes the processing flow using FIG. 12.

### Step 1:

The user operates the terminal to open an application or web page that provides an input field for inquiries.

The terminal receives natural-language text typed or spoken by the user as input, such as “Tell me some popular recent movies I might like.”

The terminal converts the input into a structured request including at least a user identifier, a timestamp, and the inquiry text, and the terminal sends this request to the server via a network connection.

The output of this step is a network request message containing the user identifier and the inquiry text, transmitted from the terminal to the server.

### Step 2:

The server receives the network request from the terminal as input through a communication interface.

The server parses the request to extract fields such as the user identifier and the inquiry text, and the server verifies that mandatory fields are present and that authentication data is valid.

The server logs metadata such as the time of receipt and source address in a log storage.

The output of this step is a validated internal data object including the user identifier and the inquiry text, stored in the server's working memory.

### Step 3:

The server uses the inquiry text as input to a natural language processing component.

The server applies tokenization to split the text into tokens, applies part-of-speech tagging and named entity recognition to identify entities such as titles, categories, and temporal expressions, and normalizes the text (for example, converting to lower case and removing extraneous symbols).

The server computes an embedding vector for the inquiry text using a pretrained text embedding model, thereby transforming the text into a numerical representation.

The output of this step is a processed inquiry structure that includes the original text, extracted intent and attribute candidates, and the embedding vector.

### Step 4:

The server uses the user identifier and the processed inquiry structure as input to a history retrieval component.

The server issues database queries to an information storage device to retrieve past inquiry history information and response history information associated with the user identifier.

The server converts the retrieved textual history into embedding vectors using the same or a compatible embedding model and computes semantic similarity scores between the current inquiry embedding and each history embedding.

The server ranks the history entries based on similarity, recency, and other attributes, and selects a subset of relevant entries.

The output of this step is a set of selected history records and associated similarity scores, held in memory for further processing.

### Step 5:

The server uses the selected history records as input to a profile generation component.

The server aggregates features such as content categories, topics, and interaction outcomes from the history, and the server computes preference scores, for example by counting occurrences and applying weighting factors based on recency.

The server stores the aggregated results into a structured user profile, including fields such as preferred categories, disfavored categories, and typical constraints (for example, “recent” or “popular”).

The server may read an existing profile from the database and update it with new aggregated values, then write the updated profile back to the information storage device.

The output of this step is updated user profile information that encodes the user's preferences and behavior patterns.

### Step 6:

The server uses the processed inquiry structure, the selected history records, and the user profile information as input to a summarization and selection component.

The server truncates or compresses long history texts into concise summaries by extracting key sentences or entities and by discarding redundant portions, while preserving essential semantic content.

The server optionally applies diversity constraints so that the selected summaries cover different aspects of the user's interests rather than repeating nearly identical items.

The output of this step is a set of concise history summaries and a compact profile summary suitable for inclusion in a prompt sentence.

### Step 7:

The server uses the compact history summaries, the profile summary, and the current inquiry text as input to a prompt construction component.

The server assembles a prompt sentence in a predetermined structure, for example placing a role description first, followed by history context, profile context, and the current inquiry plus explicit instructions.

The server may, for example, construct a prompt sentence as:
“System: You are a recommendation assistant that uses the user's past viewing and query history to recommend suitable content. You respond concisely and clearly.
History: The user previously liked the science-fiction and action movies ‘Movie X’ and ‘Movie Y’. The user often asks for recent releases and avoids horror movies.
   User profile: The user prefers science-fiction and action content, and tends to favor recent popular items.
   Current query: Tell me some popular recent movies I might like.
   Instruction: Based on the history and preferences above, suggest 3-5 recent popular movies that match the user's tastes. For each movie, provide a brief explanation of why it is a good match.”

The output of this step is a finalized prompt sentence string to be provided to the generative AI model.

### Step 8:

The server uses the prompt sentence as input to a generative AI model interface component.

The server formats the prompt sentence into a request suitable for the generative AI model, sets parameters such as maximum output length and temperature, and transmits the request via a network or an internal interface to the generative AI model.

The generative AI model, implemented as a neural network, processes the tokenized prompt through multiple attention and feed-forward layers and produces a sequence of output tokens that form a response text.

The server receives this response text along with any usage metadata from the generative AI model.

The output of this step is raw response information generated by the generative AI model in natural language form.

### Step 9:

The server uses the raw response information as input to a post-processing component.

The server checks the response for length limits, removes or masks disallowed terms according to predefined rules, and may reformat the response text into sections or bullet points based on content patterns.

The server may also attach structured recommendation items by matching mentioned entities with entries in a catalog database, thereby enriching the response.

The output of this step is cleaned and optionally enriched response information, structured for storage and for display.

### Step 10:

The server uses the inquiry text, the user identifier, and the cleaned response information as input to a storage component.

The server creates a new history record including fields such as the inquiry text, the response text, timestamps, profile-related tags, and performance metrics, and writes this record into the information storage device using a database management system.

The server may also update aggregate values in the user profile, for example incrementing counters for categories appearing in the new response.

The output of this step is an updated database state in which the new interaction is stored and available for future retrieval.

### Step 11:

The server uses the cleaned response information as input to a response transmission component.

The server encapsulates the response information in a network message in a format understandable by the terminal, and the server transmits this message to the terminal via the network interface.

The terminal receives the message, parses the contents, and extracts the response text and any structured recommendation data.

The output of this step is a response payload delivered from the server to the terminal.

### Step 12:

The terminal uses the response payload as input to a rendering component.

The terminal displays the response text on the screen in a chat-style or result-view interface and renders any recommended items as interactive elements such as list entries or cards.

The user views the displayed response and, if desired, interacts with the recommended items or enters a follow-up inquiry, which the terminal will again package and send to the server as in the earlier steps.

The output of this step is a visual presentation of the response information on the terminal and optional further user input for subsequent processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented support systems that utilize a generative AI model generally process each user inquiry in isolation. In typical architectures, a server receives a natural language inquiry, forwards the inquiry as-is to a generative AI model, and returns the model's response to a user terminal. Such architectures do not systematically capture structured information from the inquiry, do not persist and exploit interaction history as machine-usable data, and do not integrate that history with a searchable repository of human experts. As a result, several technical problems arise in terms of computer technology.
First, conventional systems fail to construct and maintain a machine-readable knowledge layer that combines user prompt sentences, extracted semantic features, AI-generated responses, and expert metadata in a consistent storage structure. Without a structured information recording device that the generative AI model can explicitly reference, the server is required to repeatedly process similar inquiries from scratch, leading to redundant computation, inefficient use of processing resources, and increased latency on shared computing infrastructure.
Second, conventional systems lack a technical mechanism on the server side to analyze prompt sentences with natural language processing programs, determine a problem field, and automatically search a structured expert repository. In many existing deployments, expert referral, if present at all, is handled outside the system by manual human routing or by simple rule-based mapping with limited semantic understanding. This prevents the server from leveraging efficient database queries based on extracted keywords or important phrases, and hinders optimization of data access patterns, indexing strategies, and memory usage in the information recording device.
Third, conventional architectures do not tightly couple a generative AI model with a persistent history store in a way that allows the model to re-use relevant prior prompts, analysis results, and expert outcomes as part of new model inputs. As a consequence, the server cannot systematically compose prompts that incorporate retrieved historical interaction data and expert information, and therefore cannot reduce repeated inference operations or improve response coherence for similar problem domains. This leads to increased computational load on processing units, inefficient use of accelerator hardware, and non-optimal use of database bandwidth.
Fourth, conventional systems do not provide a robust technical mechanism to analyze user state information (for example, urgency, confusion level, or other inferred conditions) from the text of a prompt sentence and encode that state into a structured input to the generative AI model. Without such analysis and encoding on the server, the model is unable to adapt its behavior at the system level based on machine-detectable state parameters, resulting in uniform responses that do not exploit the full expressive capacity of the model and the underlying hardware.

Accordingly, there is a need for an improved computer-implemented system and server-side processing technique that: (i) systematically analyzes prompt sentences to extract structured semantic data; (ii) integrates a generative AI model with a searchable information recording device containing interaction history and expert attributes; (iii) uses this integrated store to efficiently identify and rank expert candidates; and (iv) composes enhanced prompts for the generative AI model that incorporate retrieved history and user state information. Such a system is required to improve processing efficiency, response relevance, and overall utilization of computing resources involved in providing expert-assisted problem resolution.

The specific processing by the specific processing unit 290 of the data processing device 12 in Example 2 is realized by the following means.

The present invention provides a server comprising a processor configured to receive, from a terminal operated by a user, a prompt sentence as analysis target data; to input the prompt sentence into a natural language processing program and extract at least one keyword or important phrase to obtain an analysis result; to identify, based on the analysis result and a predefined decision rule, a problem field or expert field corresponding to the prompt sentence and to search, from an information recording device managed as a storage device by a data management program, at least one candidate expert associated with the problem field or the expert field; to store, in the information recording device, past interaction histories with a generative AI model, prompt sentences, analysis results, and attribute information of candidate experts in a machine-readable structure such that the generative AI model is configured to refer to the information recording device; to generate, for the generative AI model, a composite prompt including the prompt sentence and at least one of a related interaction history or expert information retrieved from the information recording device, to cause the generative AI model to execute response generation processing based on the composite prompt, and to append a response result to the information recording device; to evaluate information of the candidate expert obtained as a search result using an evaluation rule, to perform at least one of selection or ranking of the candidate expert, and to provide information of a selected or ranked expert to the terminal; to refer to past prompt sentences, past response results of the generative AI model, and stored expert information in the information recording device to estimate at least one of a solution candidate or an expert candidate for a currently received prompt sentence and to reflect an estimation result in at least one of input to the generative AI model or output to the terminal; and to analyze state information of the user from expressions included in the prompt sentence using a natural language processing technique and to add an analysis result as part of the composite prompt supplied to the generative AI model so that the generative AI model generates at least one of an adjusted response or expert information in accordance with the state information. This enables the server to technically improve processing of user inquiries by reducing redundant generative inference, by optimizing database access through keyword-based expert retrieval, by reusing structured interaction history as model input, and by adapting responses and expert recommendations based on machine-analyzed user state, thereby enhancing computational efficiency, latency characteristics, and relevance of outputs on computing hardware executing the generative AI model and associated data management components.

The term “processor” refers to a hardware computation unit or a combination of hardware computation units, including at least one central processing unit and optionally an accelerator or coprocessor, that executes instructions of one or more programs to perform the operations described herein.
The term “terminal” refers to an information processing apparatus operated by a user, such as a computing device with an input/output interface, that transmits a prompt sentence to a server and receives information including responses or expert information from the server.
The term “user” refers to an operator, which may be an individual or an organization acting through a person, that interacts with the system by providing a prompt sentence via a terminal and receiving results generated by the system.
The term “prompt sentence” refers to a natural language text string or equivalent user input that describes a problem, inquiry, or request and that is supplied from a terminal to the server for analysis and processing.
The term “natural language processing program” refers to a software component or set of software components that performs computational analysis of natural language text, including at least one of tokenization, part-of-speech tagging, phrase extraction, keyword extraction, entity recognition, or semantic analysis, to generate structured data from a prompt sentence.
The term “analysis result” refers to structured data derived from processing a prompt sentence by the natural language processing program and/or other algorithms, including at least one of extracted keywords, important phrases, identified entities, or classified categories.
The term “keyword” refers to a word, term, or token extracted from a prompt sentence that is determined to be relevant for characterizing the content, problem field, or expert field associated with the prompt sentence.
The term “important phrase” refers to a sequence of two or more tokens extracted from a prompt sentence that semantically represents a key concept, condition, or context for the problem described by the prompt sentence.
The term “problem field” refers to a classification or category of a technical, legal, business, or other domain to which the content of a prompt sentence is determined to belong based on the analysis result and decision rules.
The term “expert field” refers to a classification or category representing a domain of expertise associated with an expert, such as a field of specialization, that can be matched with the problem field inferred from a prompt sentence.
The term “expert” refers to a human resource or an organizational resource having registered attributes indicating a capability to address a particular problem field or expert field, and that can be recommended or presented to the user by the system.
The term “candidate expert” refers to an expert retrieved from the information recording device whose attributes match, at least in part, a problem field or expert field identified from a prompt sentence.
The term “information recording device” refers to a storage subsystem or combination of storage subsystems, such as a database or other persistent memory structure, that stores interaction histories, prompt sentences, analysis results, expert attributes, and other related data in a machine-readable format.
The term “data management program” refers to a software component or set of software components that controls storage, retrieval, update, and deletion of data in the information recording device, and manages data structures, indices, and access procedures.
The term “interaction history” refers to a stored record of past exchanges between a user (or terminal) and a generative AI model, including at least one of past prompt sentences, corresponding generated responses, timestamps, and associated metadata.
The term “attribute information” refers to structured data describing properties of an expert, including at least one of identification data, a field of expertise, tags, contact data, and performance or evaluation metrics.
The term “generative AI model” refers to a machine learning model, such as a neural network-based model, configured to generate natural language or other output content in response to input data, including at least one of a prompt sentence and additional contextual information.
The term “composite prompt” refers to an input structure provided to the generative AI model that includes a current prompt sentence and at least one additional element such as a related interaction history, expert information, analysis results, or user state information.
The term “response result” refers to output content generated by the generative AI model in response to a prompt or composite prompt, including at least one of text, metadata, or structured recommendations suitable for storage in the information recording device.
The term “evaluation rule” refers to a set of predefined criteria or algorithms used by the processor to assess, select, or rank candidate experts, based on factors such as relevance, past performance, field matching, or other attributes.
The term “solution candidate” refers to a proposed resolution, guidance, or answer inferred by the processor for a prompt sentence, based at least in part on past interaction histories, generative AI model outputs, or stored expert information.
The term “expert candidate” refers to a candidate expert that is estimated or inferred by the processor to be suitable for addressing a currently received prompt sentence, based on similarity to past inquiries and associated outcomes.
The term “user state information” refers to inferred or derived data representing a condition or context of the user, such as urgency, sentiment, confusion level, or other characteristics, obtained by analyzing expressions in the prompt sentence.
The term “adjusted response” refers to a response result generated by the generative AI model that has been influenced or conditioned by user state information, such that tone, content, or structure of the response is modified in accordance with the inferred user state.

In one embodiment, a server executes a program that implements a system for processing a prompt sentence provided by a user, analyzing the prompt sentence using a natural language processing program, storing and reusing interaction history with a generative AI model in an information recording device, and selecting and presenting an expert to the user based on structured data derived from the prompt sentence. The server cooperates with a terminal operated by the user and with a storage subsystem that serves as the information recording device.

The server uses hardware including at least one central processing unit and, in some embodiments, a graphics processing unit or other accelerator configured to execute numerical operations for a generative AI model. The server runs an operating system such as a general-purpose server operating system and executes application programs implemented, for example, in an interpreter-based environment or a compiled environment. The server communicates with the terminal and with the information recording device via one or more communication interfaces using standard communication protocols.

The terminal operates as a client device such as a general-purpose computing device, a handheld device, or another information processing apparatus. The terminal executes a user interface program, such as a web browser or a dedicated application, that displays a text input field and an output area. The user operates the terminal to input a prompt sentence describing a problem or question. For example, the user inputs one of the following prompt sentences:
“I have a question about a specific law. Which expert should I consult?”
“I am facing a data privacy issue under GDPR. Which specialist is suitable to help me?”
“I would like to consult about environmental law issues related to factory emissions.
Which expert should I talk to?”

The terminal converts the user's input into character-encoded digital data and transmits the prompt sentence to the server through a communication network. The server receives the prompt sentence and stores it in a volatile memory area as analysis target data.

The server applies a natural language processing program to the prompt sentence. In one embodiment, the server executes an open-source natural language processing library such as spaCy or NLTK on a runtime environment such as a Python interpreter. The server loads a language model, which may be a statistical model or a neural embedding model, that has been trained on general-purpose text corpora. The natural language processing program performs tokenization, part-of-speech tagging, dependency parsing, and named entity recognition on the prompt sentence. The server obtains intermediate structures such as token lists, parse trees, and entity labels as internal data structures in memory.

The server uses the output of the natural language processing program to extract keywords and important phrases. The server applies a keyword extraction algorithm using scoring measures such as term frequency-inverse document frequency, mutual information, or attention scores derived from a neural language model. The server additionally applies phrase-chunking rules or learned phrase segmentation to obtain multi-token expressions that represent concepts in the prompt sentence. For instance, from the prompt sentence “I am facing a data privacy issue under GDPR. Which specialist is suitable to help me?”, the server may extract keywords and phrases such as “data privacy,” “GDPR,” and “specialist.”

The server maps the extracted keywords and important phrases to a problem field and an expert field. The server maintains a rule set and, in some embodiments, a trained classifier model. The server implements the rule set as a mapping between normalized keyword vectors and domain labels stored in a configuration structure. The server performs vectorization of extracted tokens using an embedding method such as word embeddings or sentence embeddings. The server calculates similarity scores between the vector representing the prompt sentence and vectors representing known domains by using a distance measure such as cosine similarity. The server identifies a problem field and an expert field by choosing a label with a maximum similarity score above a threshold. This mapping process differs from manual human routing because the server uses numerical vector operations and threshold-based classification that are not naturally performed by human operators and that are optimized for execution on the server's processors.

The server stores the prompt sentence, the extracted keywords, the important phrases, and the identified problem field and expert field in the information recording device. The information recording device is implemented as a database system such as a relational database management system, for example a system conforming to SQL standards, running as a server process on the same machine or on a separate machine. The server uses a data management program such as a database driver or an object-relational mapping library to execute structured queries and manage persistent storage.

The server defines data structures in the information recording device that are optimized for the processes described herein. For instance, the server constructs a table for user interactions that stores, as fields, a unique interaction identifier, a user identifier, a timestamp, the prompt sentence, the extracted keywords as a serialized list, the extracted important phrases, the identified problem field, the identified expert field, and references to expert records. The server creates indices on fields such as problem field, expert field, and keyword tokens. By designing the database schema and indices in this manner, the server can perform efficient search and retrieval operations based on combinations of textual features and categorical fields, thereby reducing search time and input/output load compared to naive scanning.

The server stores expert information in an expert table that includes fields for an expert identifier, a field of expertise, descriptive tags, contact information, and performance metrics. The descriptive tags and field of expertise are stored as normalized strings or identifiers. The server indexes the expert table on fields such as field of expertise and tags so that queries based on extracted keywords can be executed with low latency. The server thereby improves data management efficiency and reduces the computational cost of expert search operations.

The server uses a generative AI model configured as a parametric function represented by a neural network. In one embodiment, the generative AI model is a transformer-based neural network trained on large text corpora to perform next-token prediction. The model comprises multiple layers of self-attention blocks and feedforward networks. Each layer includes matrix multiplications, non-linear activation functions, and normalization operations. The server stores model parameters (weights and biases) on a storage medium and loads them into memory and, when available, into accelerator memory such as graphics memory.

The server trains the generative AI model or uses a pre-trained model and optionally performs fine-tuning using domain-specific data. In training, the server uses a loss function such as cross-entropy between predicted token distributions and ground-truth next tokens. The server updates weights using gradient-based optimization such as stochastic gradient descent or adaptive optimization algorithms. The server may also perform data augmentation, including paraphrasing or synonym replacement, to expand training samples. During training, the server adjusts learning rates, batch sizes, and regularization parameters to optimize convergence and generalization.

The server configures the generative AI model to accept a composite prompt that includes the current prompt sentence and additional context. The server generates the composite prompt by concatenating the prompt sentence with retrieved interaction history or expert information. For example, the server fetches from the information recording device past interaction records that share similar problem fields or expert fields. The server calculates similarity using vector representations of past prompts and the current prompt, uses a nearest neighbor algorithm to find relevant past records, and extracts portions of dialogue text and associated expert outcomes. The server then constructs a composite text that includes the current prompt sentence followed by selected excerpts labeled as context.

The server supplies the composite prompt to the generative AI model. The generative AI model internally encodes the input tokens to embeddings, processes the embeddings through the stacked transformer layers, and generates a probability distribution over output tokens at each position. The server instructs the generative AI model to generate a response result using decoding strategies such as greedy decoding or beam search. The server then receives the response result as a generated text sequence.

The server appends the response result to the interaction history stored in the information recording device. The server associates the response result with the corresponding prompt sentence and analysis results using foreign keys in the database tables. This append operation increases the number of historical records that can be used as context for future composite prompts. By storing tightly structured data in this way, the server enables repeated reuse of relevant context for similar inquiries. This reduces the need to process each prompt from a blank context and thereby decreases total computation time and power consumption for inference.

The server further analyzes user state information from the prompt sentence. The server uses a classifier model, which may be implemented as a smaller neural network or as a rule-based component, to assign labels such as urgency levels or sentiment categories to the prompt sentence. The server derives feature vectors from token embeddings or from the outputs of the natural language processing program. The server feeds these feature vectors into the classifier model, which outputs probabilities for defined state categories.

The server selects a category using a maximum probability rule or a threshold comparison, stores the user state information in the information recording device, and also embeds it as a tag or structured field in the composite prompt provided to the generative AI model.

The server uses the user state information to influence the generation process by adjusting decoding parameters or by injecting explicit instructions into the composite prompt. For example, if user state information indicates high urgency, the server can encode this condition in the composite prompt or modify temperature parameters to reduce variance in generation. This technique modifies the behavior of the generative AI model based on machine-derived signals and produces distinct technical effects: the server modifies model operation parameters at runtime based on structured state features that are automatically inferred by the classifier model rather than manually chosen by a human operator.

The server searches for candidate experts by issuing structured queries to the information recording device. The server converts extracted keywords and important phrases into normalized tokens, maps them to fields such as field of expertise and tags, and composes query expressions using logical operators. The server sends the query to the database engine. The database engine uses pre-defined indices and query optimization strategies to locate candidate expert records with minimal disk access and memory overhead. The server receives candidate expert records and computes a relevance score for each candidate using evaluation rules that combine multiple features such as keyword overlap, problem field match, past performance metrics, and availability status. The server may implement the evaluation rule as a weighted linear function or as a learned scoring function. The server sorts candidate experts by relevance score and selects top-ranked experts.

The server then provides information of selected or ranked experts to the terminal. The server converts the selected expert records into a data structure suitable for display and transmits the data to the terminal. The terminal receives the expert information and displays attributes such as expert name, field of expertise, and contact method to the user. The user can then use the terminal to initiate communication with the expert using electronic communication mechanisms.

The described architecture and processing produce technical effects that go beyond abstract information processing or mere automation of a business process. The server uses specific data structures in the information recording device, including indexed tables for prompts, interaction histories, and expert attributes, and integrates these tables with a generative AI model and natural language processing program. By extracting structured features from the prompt sentence and using them as keys for database retrieval and as context for composite prompts, the server reduces redundant inference operations by the generative AI model. The server also lowers the frequency of full-domain generation because the system can reuse previous context and expert outcomes. This reduces computation time, reduces network load to external model endpoints in embodiments where the model is accessed over a network, and improves overall throughput.

The server improves accuracy and consistency of problem field identification and expert selection because it applies numerical similarity measures and rule-based evaluation to combined structured data instead of relying solely on free-text matching or manual selection. By explicitly modeling user state information, the server can adapt response generation and expert recommendation in a systematic and machine-detectable way that can be tuned by adjusting classifier thresholds or training data, resulting in improved response precision and lower mismatch rate between user intent and recommended expert.

The server's use of composite prompts and structured interaction histories allows the generative AI model to operate with context that is not readily available in conventional systems that treat each inquiry independently. This architecture reduces the need to increase model size or compute resources merely to capture more context. Instead, the server externalizes context management to the information recording device and precisely selects relevant context, which is then fed back into the generative AI model. This division of responsibilities between database and model yields improved memory usage and processing efficiency, providing a technical improvement in how computing resources are orchestrated.

In an alternative embodiment, the server uses a different type of generative AI model, such as an encoder-decoder architecture, a recurrent neural network, or a mixture-of-experts model. The server adapts the composite prompt generation process to the input format of the chosen architecture. In another embodiment, the server replaces the natural language processing library with another library or a custom model that performs similar token-level and sentence-level analysis, while maintaining the described data flow between prompt sentence, analysis result, and information recording device.

In another variant, the server deploys the information recording device across multiple physical storage nodes. The server uses a distributed data management program that partitions records according to problem field or expert field and replicates frequently used segments. The server thereby reduces query latency for frequent domains and increases fault tolerance. By designing the distribution scheme with respect to the extracted features, the server further reduces inter-node communication and improves throughput.

In another embodiment, the terminal performs part of the natural language pre-processing, such as tokenization and simple keyword extraction, before sending the prompt sentence to the server. The server receives pre-processed data in addition to the original prompt sentence and merges both for further analysis. This configuration can balance computation between the terminal and the server and reduce the amount of raw data transmitted over the network in bandwidth-constrained environments.

Through these embodiments and variations, the server, the terminal, and the information recording device cooperate to implement a concrete, technically detailed data flow and set of algorithms that improve the operation of computing hardware used for generative AI tasks. The system does not merely replicate human routing activities but instead uses numerical models, structured data storage, and specialized processing steps to achieve improvements in processing speed, resource utilization, and accuracy of expert recommendation and response generation.

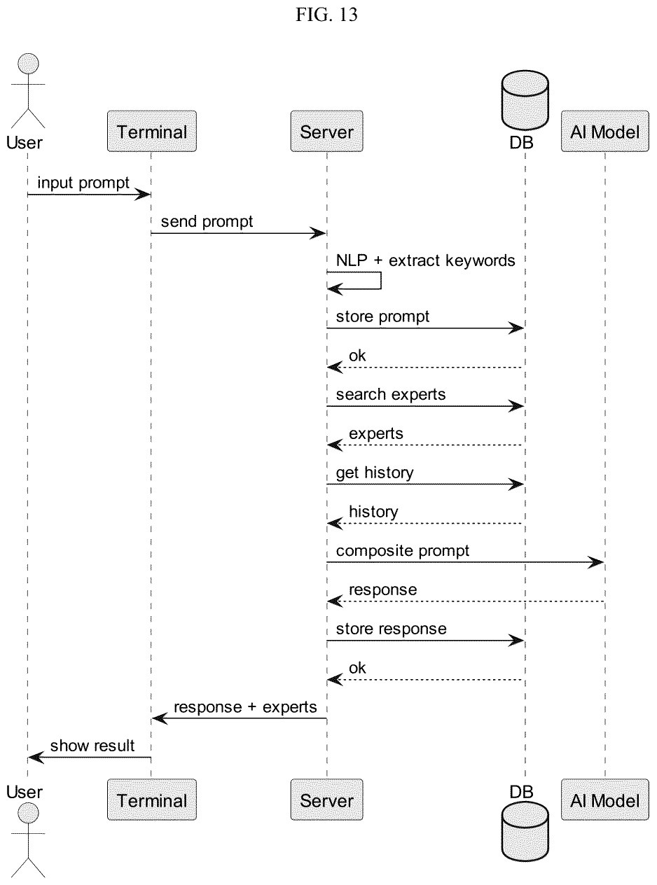

The following describes the processing flow using FIG. 13.

### Step 1:

User operates the terminal to input a prompt sentence.

User launches an application on the terminal, such as a browser or native application, and types a natural language prompt sentence describing a problem or question into a text input field.
Input: User's textual problem description (prompt sentence), for example, “I have a question about a specific law. Which expert should I consult?”
Output: Character-encoded text held in the terminal's memory buffer.
Terminal converts keypress events into a character string and stores the string as an internal variable representing the prompt sentence.

### Step 2:

Terminal transmits the prompt sentence to the server.

Terminal packages the prompt sentence together with metadata such as a user identifier and timestamp into a request message and sends the message to the server via a network protocol.
Input: Prompt sentence string and local metadata.
Output: Network packet containing the prompt sentence and metadata delivered to the server.

Terminal serializes the prompt sentence into a payload format, attaches headers including destination address and content type, and issues a network send operation to a predefined server endpoint.

### Step 3:

Server receives the prompt sentence and stores it as analysis target data.

Server accepts the incoming network packet, parses the message headers and payload, and extracts the prompt sentence and associated metadata.
Input: Network message received from the terminal.
Output: Prompt sentence string and metadata stored in volatile memory on the server.

Server decodes the payload encoding, validates the data, and writes the prompt sentence into a data structure such as a request object, which is then passed to subsequent processing modules.

### Step 4:

Server applies a natural language processing program to the prompt sentence.

Server invokes a natural language processing library and loads a language model into memory, then supplies the prompt sentence as input for linguistic analysis.
Input: Prompt sentence string.
Output: Structured linguistic representation including token list, part-of-speech tags, dependency relations, and candidate entities.

Server performs tokenization to split the text into tokens, assigns part-of-speech tags using a trained tagging model, computes dependency arcs using a parsing algorithm, and identifies named entities using a statistical or neural entity recognizer.

### Step 5:

Server extracts keywords and important phrases from the analysis result.

Server uses scoring rules and phrase-chunking logic to determine which tokens and token sequences are most relevant to the prompt sentence.
Input: Structured linguistic representation from the natural language processing program.
Output: Keyword list and important phrase list stored as structured data (for example, arrays of normalized strings).

Server computes scores such as term frequency-inverse document frequency or attention-weight proxies for each token and contiguous token span, filters out low-scoring elements, and normalizes remaining tokens (for example, lowercasing and lemmatization) to construct keyword and phrase lists.

Step 6:

Server identifies a problem field and expert field based on the extracted features.

Server converts keywords and important phrases into vector representations and compares them with stored domain vectors to classify the prompt sentence.
Input: Keyword list and important phrase list.
Output: Problem field label and expert field label.

Server maps each keyword to an embedding vector, aggregates vectors using averaging or weighted combination, calculates similarity scores between the aggregated vector and pre-stored vectors representing known problem domains, selects the domain with the highest similarity above a threshold as the problem field, and maps this to a corresponding expert field via a predefined mapping table.

### Step 7:

Server stores the prompt-related data in the information recording device.

Server uses a data management program to insert a new record representing the current interaction into persistent storage.
Input: Prompt sentence, keyword list, phrase list, problem field, expert field, and metadata.
Output: Database record inserted into a user interaction table, with a generated interaction identifier.

Server constructs an insertion command that includes the fields, submits the command to the database engine, receives confirmation of successful write, and stores the returned interaction identifier in memory for linking to subsequent data such as generated responses.

### Step 8:

Server searches for candidate experts using the identified fields and extracted features.

Server formulates a structured query that matches the problem field, expert field, and related tags in an expert table in the information recording device.
Input: Problem field label, expert field label, and keyword list.
Output: Candidate expert records retrieved from the database, each containing structured attribute information.

Server composes a query with conditions on expert specialization and descriptive tags, sends the query to the database engine, and receives a set of expert rows that satisfy search criteria. The database engine uses indices and query planning to minimize access time, and the server deserializes the returned rows into expert objects.

### Step 9:

Server evaluates and ranks candidate experts.

Server applies evaluation rules that compute a relevance score for each candidate based on multiple attributes.
Input: Candidate expert records and extracted feature data.
Output: Ranked list of experts with associated scores.

Server calculates a composite score by combining factors such as number of matched keywords, exact match with problem field, historical performance metrics, and availability flags using a weighted sum or scoring function, sorts the candidate experts in descending order of score, and truncates the list to a predetermined maximum number.

### Step 10:

Server retrieves interaction history relevant to the current prompt sentence.

Server queries the information recording device for past interactions whose problem field or expert field matches or is similar to the current ones.
Input: Problem field, expert field, and vector representation of the current prompt sentence.
Output: Set of past interaction records including prior prompt sentences and response results.

Server performs a query constrained by fields such as problem field and then computes similarity measures between stored prompt representations and the current prompt representation, filters records by a similarity threshold, and returns the top relevant interaction histories for possible reuse.

### Step 11:

Server analyzes and determines user state information from the prompt sentence.

Server passes feature vectors derived from the prompt sentence to a classifier that estimates user state categories.
Input: Prompt sentence representation and linguistic features.
Output: User state label such as urgency level or sentiment category.

Server aggregates token-level features (for example, embedding vectors and sentiment indicators) into a fixed-length vector, feeds the vector to the classifier model, obtains probability values for each user state category, selects the highest-probability category, and stores this category as structured user state information in memory and in the interaction record.

### Step 12:

Server constructs a composite prompt for the generative AI model.

Server concatenates the current prompt sentence with selected interaction history, expert-related context, and user state information in a structured textual format.
Input: Prompt sentence, relevant interaction histories, user state label, and optionally preliminary expert information.
Output: Composite prompt text prepared for input to the generative AI model.

Server selects excerpts from past dialogues and response results, formats them as context sections, inserts user state indicators as explicit instructions or tags, and joins these components into a unified text string that encodes both the current request and the retrieved contextual information.

### Step 13:

Server generates a response result using the generative AI model.

Server supplies the composite prompt to the generative AI model and runs inference to obtain a generated text output.
Input: Composite prompt text.
Output: Generated response text that addresses the user's inquiry and may reference recommended experts.

Server tokenizes the composite prompt into input tokens, loads corresponding embeddings, processes the tokens through the layers of the neural network by performing matrix multiplications, non-linear activations, and attention operations, decodes the output token probabilities using a decoding algorithm such as greedy search or beam search, and reconstructs the generated response text from the resulting token sequence.

### Step 14:

Server stores the response result and links it with the interaction record.

Server appends the generated response text and associated metadata to the previously created interaction record in the information recording device.
Input: Generated response text and interaction identifier.
Output: Updated interaction record containing both prompt and response data.

Server constructs an update command that sets response-related fields, executes the command on the database engine, and confirms that the interaction record is updated, thus preserving a complete history for reuse in future composite prompts.

### Step 15:

Server prepares expert information and response data for transmission to the terminal.

Server selects top-ranked experts, formats their attributes, and combines this information with the generated response in a structured output representation.
Input: Ranked expert list and generated response text.
Output: Response package containing expert information and AI-generated text.

Server extracts fields such as expert identifier, field of expertise, and contact information from the ranked list, organizes them into a response structure alongside the generated response, and serializes this structure for network transmission.

### Step 16:

Server sends the response package to the terminal.

Server transmits the combined expert information and generated response through the network using an appropriate communication protocol.
Input: Serialized response package in server memory.
Output: Network message delivered to the terminal containing the generated response and expert details.

Server sets transmission parameters such as destination address and message size, invokes network send operations, and monitors for completion or error conditions, ensuring that the terminal receives the complete data.

### Step 17:

Terminal receives and displays the generated response and expert information.

Terminal parses the incoming message to separate the response text from the expert data and renders them on the user interface.
Input: Network message containing the response package.
Output: Visual presentation of the generated response and expert list on the terminal's display.

Terminal decodes the serialized data, maps expert attributes to display elements such as list items or cards, presents the generated response in a text area, and updates interactive controls such as buttons that allow the user to initiate contact with a selected expert.

### Step 18:

User reviews the output and optionally initiates contact with a recommended expert.

User reads the generated response text and the displayed expert information on the terminal and chooses whether to interact with one of the experts.
Input: Displayed response and expert list as perceived by the user.
Output: User action such as selecting an expert or inputting a follow-up prompt sentence.

User may activate a contact control associated with a specific expert, causing the terminal to open a communication interface or to send a further request to the server, or may enter a new prompt sentence, which restarts the processing flow from the initial reception and analysis steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern communication systems that employ natural language interfaces and machine-generated responses, several technical problems arise in efficiently and accurately handling user inquiries at scale. Conventional systems typically treat each user inquiry as an isolated transaction, relying on simple rule engines or generic machine learning models that do not effectively reuse accumulated interaction history or exploit fine-grained emotion information. As a result, such systems suffer from increased processing latency, reduced response accuracy, and inconsistent user experience when confronted with complex or specialized inquiries.

In particular, existing systems generally fail to (i) systematically structure and store interaction history in a form that supports high-speed similarity search and contextual reuse of past responses by a generative AI model, (ii) dynamically construct and adapt prompt sentences for the generative AI model based on both semantic analysis and emotion analysis of user inputs, and (iii) automatically determine when to escalate an inquiry to a human expert and to technically manage the routing and connection between a user device and an expert device. These limitations manifest as additional processor cycles for repetitive generation of essentially similar responses, inefficient use of database and model resources, and non-deterministic quality of responses across sessions.

Furthermore, conventional architectures often separate intent routing, emotion analysis, response generation, and expert handoff into loosely coupled subsystems without an integrated control flow. This fragmented design increases inter-component communication overhead, complicates state management, and makes it difficult to optimize end-to-end latency and throughput. The lack of a unified mechanism to compute and store feature information for interaction records also prevents effective similarity computation and reuse of past solutions, thereby underutilizing stored data and computational results.

Accordingly, there is a need for an improved computer-implemented system that (1) captures and stores inquiries, analysis results, prompt sentences, and generated responses as structured interaction history together with computed feature information, (2) performs similarity-based retrieval over this history to automatically construct context-enhanced prompt sentences for a generative AI model, (3) integrates emotion analysis into prompt construction to adjust response style and content, and (4) automatically identifies and connects appropriate expert entities based on topic information. Such a system should improve computational efficiency, reduce response generation time, and increase the consistency and appropriateness of responses from the perspective of computer system performance and resource utilization.

The specific processing by the specific processing unit 290 of the data processing device 12 in Application Example 2 is realized by the following means.

The present invention provides a server comprising a processor and at least one storage device, the processor being configured to execute computer-readable instructions to: receive inquiry information from a user terminal via a communication network and perform natural language processing on the inquiry information to extract intent information, topic information, and emotion information; apply predefined rule information to the intent information and the topic information to determine a routing result that associates the inquiry information with at least one processing function or at least one response entity having specialized knowledge; construct, based on the inquiry information and an analysis result including the intent information, the topic information, and the emotion information, a prompt sentence for instructing a generative information processing model to generate response information in natural language, and cause the generative information processing model to generate the response information; store, in the storage device as interaction history, the inquiry information, the analysis result, the prompt sentence, and the response information in association with each other, and compute and store feature information associated with at least the inquiry information or the analysis result; when new inquiry information is received, retrieve, from the interaction history in the storage device, similar past cases by performing similarity calculation based on the feature information, and dynamically generate a prompt sentence that includes response information of the similar past cases as input context for the generative information processing model so as to improve accuracy and speed of response generation; adjust the prompt sentence for the generative information processing model based on the emotion information so that the response information generated by the generative information processing model has a response style and expression content corresponding to a user emotion state; and extract, based on at least one of the topic information and the response information, candidates for the response entity having specialized knowledge from expert information stored in the storage device, present the candidates to the user terminal, and control establishment of a communication connection between the user terminal and a terminal of a selected response entity. This enables an integrated computer system to reduce computational redundancy by reusing stored interaction history in generating responses, to lower end-to-end response latency through similarity-based context construction, to improve response appropriateness by dynamically incorporating emotion information into prompt sentences, and to technically manage automated routing and connection to expert entities, thereby enhancing overall efficiency and performance of computer-implemented inquiry handling.
The term “inquiry information” refers to data representing a request, question, or instruction provided by a user, the data being expressed in natural language text, speech converted to text, or another machine-processable representation that can be analyzed by the system.
The term “user terminal” refers to an information processing apparatus operated by a user, such as a computing device or communication device, that transmits inquiry information to a server and receives response information via a communication network.
The term “natural language processing” refers to a computational technique for analyzing and processing human language, including at least one of tokenization, morphological analysis, syntactic analysis, semantic analysis, entity extraction, intent classification, and similar linguistic operations.
The term “intent information” refers to information indicating a purpose or objective of a user's inquiry, derived by analyzing the inquiry information with natural language processing to classify the inquiry into at least one intent category.
The term “topic information” refers to information indicating a subject matter or domain associated with a user's inquiry, derived by analyzing the inquiry information with natural language processing to extract keywords, entities, or domain labels.
The term “emotion information” refers to information indicating an estimated emotional state of a user, such as worry, anger, joy, or neutrality, obtained by analyzing at least one of text data, audio data, or image data associated with the inquiry information.
The term “predefined rule information” refers to machine-readable rule data that specifies conditions and corresponding actions, used by the processor to determine routing of an inquiry to at least one processing function or response entity based on intent information and topic information.
The term “processing function” refers to a logical or software-based operation executed by the system, such as automatic response generation, information retrieval, or escalation handling, that processes inquiry information without direct human intervention.
The term “response entity” refers to an actor capable of providing a response to an inquiry, including at least one of a human expert, a human operator, or a specialized automated subsystem having knowledge or capabilities related to the topic information.
The term “specialized knowledge” refers to domain-specific expertise, experience, or technical information associated with a particular field, such as a legal, technical, medical, or business domain, that enables a response entity to handle specialized inquiries.
The term “generative information processing model” refers to a machine learning model, including a generative AI model, configured to generate natural language text or other data by performing inference based on a prompt sentence and optionally additional context information.
The term “prompt sentence” refers to a text string or structured instruction provided as input to a generative information processing model, the text string including at least part of the inquiry information and analysis result to guide generation of response information.
The term “response information” refers to information generated by the generative information processing model or by a response entity, the information being expressed in natural language or another format suitable for presentation to a user.
The term “analysis result” refers to data produced by processing the inquiry information with natural language processing and emotion analysis, including at least one of intent information, topic information, emotion information, and derived classification data.
The term “information recording device” refers to a storage resource, such as a database system, memory system, or file storage system, used to store interaction history, feature information, expert information, and other data used by the processor.
The term “interaction history” refers to stored records that associate, for each interaction, inquiry information, analysis result, prompt sentence, response information, timestamps, and related metadata, enabling subsequent retrieval and reuse.
The term “feature information” refers to numerical or symbolic data computed from at least the inquiry information or the analysis result, such as vector representations, keyword sets, or indices, used to perform similarity calculations among interaction records.
The term “similarity calculation” refers to a computational process that evaluates closeness or relatedness between pieces of information, such as between feature information of different interaction records, using at least one of distance metrics, correlation metrics, or matching scores.
The term “similar past cases” refers to interaction history records identified as having feature information with similarity to feature information of new inquiry information according to a similarity calculation.
The term “input context” refers to supplemental information, including at least one of past response information, past inquiry information, and analysis results, that is included together with a prompt sentence as input to a generative information processing model to influence generated output.
The term “expert information” refers to stored data describing response entities with specialized knowledge, including at least identifiers, domain labels, skills information, and communication information, used for selecting candidates for expert consultation.
The term “communication connection” refers to a logical or physical linkage established over a communication network between a user terminal and a terminal of a response entity, the linkage enabling at least one of message exchange, voice communication, or video communication.
The term “user emotion state” refers to a representation of a user's emotional condition at a given time, derived from emotion information, and used by the processor to adjust content and style of response information generated for that user.

In one embodiment, a server implements the claimed system by executing computer-readable instructions on a processor and cooperating with at least one storage device and at least one user terminal over a communication network.

### A. Overall Configuration

The server uses a general-purpose computing platform including a central processing unit (CPU), an optional graphics processing unit (GPU) or dedicated accelerator for neural network inference, a main memory, and a non-volatile storage device. The server executes an operating system such as a general-purpose server operating system, and runs application software implemented, for example, in a high-level language environment. The server communicates with user terminals and expert terminals via a network interface using a protocol such as HTTP or HTTPS.

The terminal uses a computing device such as a smartphone, tablet, wearable display device, or personal computer. The terminal includes at least a display module, an input module such as a touch panel or keyboard, and optionally a microphone and camera. The terminal runs an application or web browser that transmits inquiry information to the server and presents response information received from the server.

The user operates the terminal to input inquiry information in natural language, to review response information, and to select an expert entity when presented.

### B. Inquiry Reception and Parsing

The server receives inquiry information from a user terminal. The inquiry information is, in one embodiment, a text string entered by the user through a graphical user interface. Alternatively, the terminal captures user speech via the microphone and uses a speech recognition service to convert the audio signal into text. The terminal then transmits the resulting text as inquiry information to the server.

The server uses a natural language processing library, such as an open-source linguistic analysis framework, to parse the inquiry information. The server loads a pre-trained language model including tokenization rules, part-of-speech tagging rules, and syntactic dependency patterns. The server converts the inquiry information into a sequence of tokens, assigns part-of-speech tags, identifies noun phrases and verb phrases, and extracts named entities such as domain labels or technical terms.

The server generates intent information by applying a classification algorithm, such as a multi-class logistic regression model or a neural network classifier, trained on labeled examples of user intents. The server maps the inquiry information to an intent category, such as “legal consultation,” “technical troubleshooting,” or “content recommendation.”

The server generates topic information by extracting characteristic terms and mapping them to topic labels using a term-to-topic dictionary or a topic model such as a latent Dirichlet allocation model. In another embodiment, the server computes a sentence embedding vector using a transformer-based encoder model, and then assigns a topic label corresponding to the nearest cluster center in an embedding space.

The server generates emotion information by performing sentiment and emotion analysis. For text-based emotion analysis, the server uses an emotion classification model, such as a recurrent neural network or transformer-based classifier, trained to output discrete emotion categories (for example, worry, anger, joy, neutrality) and associated confidence scores. The server inputs tokenized text to the model, obtains intermediate feature vectors, and outputs emotion information including a predicted emotion category and probability distribution.

When the terminal provides audio or image data, the terminal or the server applies an emotion recognition engine that extracts acoustic features (for example, pitch, energy, spectral characteristics) and visual features (for example, facial action units, landmark points) and classifies them using a convolutional neural network or similar architecture. The server integrates the emotion estimation results from text and media channels by applying a predefined rule, such as weighted averaging of confidence scores.

By performing these specific parsing and classification operations, the server converts unstructured natural language input into structured intent information, topic information, and emotion information, which are then usable for routing and subsequent processing.

### C. Routing Using Predefined Rules

The server applies predefined rule information to the intent information and topic information to determine a routing result. The rule information is stored in the storage device as a set of machine-readable conditions and actions. For example, a rule may specify that inquiries with intent “legal consultation” and topic “intellectual property” are to be eligible for routing to legal expert entities, whereas inquiries with intent “technical troubleshooting” and topic “network connectivity” are to be processed primarily by an automated diagnostic function.

The server evaluates the intent information and topic information against the rule conditions using a rule engine. The server identifies one or more processing functions, such as automatic response generation only, automatic response generation plus expert suggestion, or mandatory expert routing. The server also identifies one or more candidate response entities having specialized knowledge in the determined topic based on domain labels registered in an expert information store.

This rule-based routing is not a mere business rule set, but a technical mechanism that reduces unnecessary calls to heavy generative models and expert search operations by pre-filtering and categorizing inquiries in a structured way, thereby decreasing processor load and improving throughput.

### D. Construction of the Prompt Sentence for a Generative AI Model

The server constructs a prompt sentence for a generative information processing model.

The generative information processing model is, in one embodiment, a generative AI model such as a large-scale transformer-based language model deployed on a remote inference service or on a local accelerator. The model comprises an encoder-decoder or decoder-only architecture with multiple attention layers, feed-forward sub-layers, layer normalization, and learned embedding matrices.

The server prepares a base instruction string representing a system role, such as:
“You are a helpful assistant that provides accurate, concise, and polite answers to user inquiries.”

The server appends to the base instruction the inquiry information, the intent information, the topic information, and the emotion information, formatted as text. For example, the server may construct a prompt sentence of the following form:
“User inquiry: I am worried about the recent data leakage.
Detected intent: security information request.
Detected topic: data protection and leakage.
Detected emotion: worry.
Instruction: Start with an appropriate apology for causing concern, explain basic data protection measures clearly, and suggest that a data protection expert can be introduced for further advice. Then provide a detailed but understandable answer.”

The server can use different prompt templates to reflect different routing results. For example, if the server determines that an expert introduction is appropriate, the server includes specific instructions to propose expert consultation.

The server thus builds a structured prompt sentence that encodes not only the user's raw text but also internal analysis results. This structure allows the generative AI model to receive fine-grained guidance, which improves output precision and reduces the need for iterative regeneration, thereby saving computational resources.

### E. Generative AI Model Structure and Training

The server interacts with a generative AI model that has been trained on large-scale text corpora. In one embodiment, the model is a transformer network comprising L layers, each layer including a multi-head self-attention block and a position-wise feed-forward block. The model uses positional encodings to represent token order, and uses layer normalization for stable training. The model has parameters including weight matrices in attention and feed-forward layers and embedding matrices for tokens.

During training, a learning algorithm such as stochastic gradient descent or an adaptive optimizer minimizes a loss function, for example, a cross-entropy loss between predicted token distributions and target tokens. The server or a training system uses mini-batch training, backpropagation through time, and gradient-based weight updates. In another embodiment, the model is fine-tuned on domain-specific data including prior user inquiries and expert answers, so that it learns domain-specific language and response patterns.

The server explicitly leverages the model's ability to process long context windows and to condition output on past response information retrieved from interaction history. The model receives the constructed prompt sentence, possibly including appended examples of similar past cases, and generates response information token by token by computing attention weights and probability distributions over the vocabulary, then selecting tokens according to a decoding strategy such as greedy decoding or nucleus sampling.

By describing the internal architecture, training method, and inference mechanism, the system establishes that the generative AI model is a concrete computational tool with a specific structure rather than an abstract “black box,” and that combining it with structured prompt sentences and similarity-based context leads to measurable improvements in computational efficiency and accuracy.

### F. Storage of Interaction History and Feature Information

The server stores interaction history in an information recording device, such as a relational database system or a document store. The server defines tables or collections including at least an “interactions” structure and a “responses” structure.

The interactions structure associates, for each interaction, a unique interaction identifier, user identifier, inquiry information, analysis results (intent information, topic information, emotion information), timestamps, and other metadata. The responses structure associates response information, prompt sentences used for generation, model version identifiers, and links to corresponding interactions.

The server computes feature information from at least the inquiry information and the analysis results. For example, the server can generate a dense vector representation for each inquiry using an embedding model, such as a transformer-based sentence encoder. The server stores the resulting embedding vector in a vector store or in a specialized feature column. Alternatively, the server computes a sparse feature vector, such as a term frequency-inverse document frequency representation, and stores this as feature information.

The server uses these data structures to support rapid similarity search. Because interaction history includes richly annotated analysis results and compact feature representations, the system can search for similar past cases in sub-linear time using approximate nearest neighbor algorithms, which improves response time and system scalability.

### G. Similarity-Based Retrieval and Dynamic Prompt Construction

When the server receives new inquiry information, the server calculates feature information for the new inquiry in the same manner as during storage. The server queries the information recording device and associated feature store to retrieve similar past cases using similarity calculations, such as cosine similarity or Euclidean distance, between feature vectors. The server identifies a set of similar past cases with similarity above a threshold or within the top N ranking.

The server then retrieves response information associated with the similar past cases. The server constructs a new prompt sentence that includes summaries or full text of one or more of these response information items as input context for the generative AI model. For example, the server may construct a prompt sentence of the following form:
“User inquiry: Please propose a marketing strategy for a new product.
Similar past answer 1:[text of previous strategy]
Similar past answer 2:[text of another strategy]
Instruction: Considering the above similar strategies, generate a refined and updated marketing strategy adapted to the current user inquiry, avoiding mere repetition and including any new relevant tactics.”

By including previous responses as context, the server enables the generative AI model to adapt, refine, or combine existing solutions instead of recomputing them from scratch. This reuse reduces inference time and computational cost, and it increases consistency and quality of responses across similar inquiries. The server's specific data structures and retrieval algorithms thus realize a technical improvement in how computer systems manage and exploit large volumes of prior interactions.

### H. Emotion-Aware Adjustment of Prompt Sentences

The server adjusts the content and style of prompt sentences based on emotion information. If the server determines that the user emotion state is worry or anger, the server injects explicit instructions into the prompt sentence to use apologetic and empathetic language, to prioritize clarity, and to avoid overly technical jargon. If the server determines that the user emotion state is joy or satisfaction, the server instructs the generative AI model to maintain a positive tone and to reinforce successful outcomes.

For example, when the emotion information indicates worry, the server can construct a prompt sentence such as:
“The user said: I am worried about the recent data leakage.
Detected emotion: worry.
Instruction: Generate a response that starts with an apology for causing concern, explains basic protection measures in clear and simple terms, and offers to connect the user with a data protection expert for further assistance.”

The server thereby uses a non-conventional, emotion-aware prompting technique that directly conditions model behavior on machine-derived emotion features. This processing is different from a human operator's intuitive adjustment because the server systematically encodes emotion information into machine-readable prompt patterns, leading to predictable and reproducible output modifications at scale, and contributes to a technical improvement in output stability and appropriateness for computer-generated text.

### I. Expert Entity Selection and Connection Control

The server maintains an expert information store that includes, for each candidate response entity, at least an identifier, domain labels, skills descriptions, and communication information. The server uses the previously extracted topic information and optionally the intent information to search this expert information store. The server applies a matching algorithm, such as keyword matching, vector similarity comparison, or a learned ranking model, to select expert candidates whose domain labels and skills best correspond to the topic information.

The server generates a compact representation of each candidate, including name-like identifiers, domain categories, and short descriptions, and sends this information to the user terminal. The user uses the terminal to select one of the candidates. The terminal transmits the selection back to the server.

The server, upon receiving the selection, initiates a communication connection between the user terminal and a terminal of the selected response entity. The server may use a communication platform or protocol to establish a real-time chat or video session. The server generates or obtains session identifiers and authentication tokens, and distributes them to the user terminal and the expert terminal.

By technically controlling the communication connection based on structured topic information and analysis results, the server reduces unnecessary human routing, lowers misrouting rates, and optimizes network resource use. This design is not a mere replacement of a human operator but a computational routing and connection mechanism that automatically selects and connects appropriate endpoints according to machine-derived features.

### J. Technical Effects and Improvements

The server improves computer technology in several ways. First, by storing interaction history with associated feature information and using similarity-based retrieval to construct context-enhanced prompt sentences, the server reduces redundant natural language generation computations. Instead of recomputing responses from the same starting point, the server reuses and refines previous solutions, decreasing inference time per request and server load.
Second, by incorporating intent information, topic information, and emotion information into prompt sentences in a structured manner, the server reduces the search space in the generative AI model's decoding process. The generative AI model can focus on a narrower set of plausible outputs, improving accuracy and reducing the rate of irrelevant responses, which constitutes a reduction in computational error and wasted cycles.
Third, by unifying routing, emotion analysis, response generation, and expert connection within a single, integrated processing pipeline, the server decreases inter-component communication overhead and simplifies state management. This integrated control leads to reduced latency and improved throughput compared to systems that handle each function in isolated subsystems.
Fourth, by using specific data structures for feature information and by employing similarity calculations suited for those structures, the server enables scalable and efficient retrieval over large datasets of interaction history. This improves memory utilization and allows the system to maintain performance even as the number of stored interactions increases.

### K. Alternative Embodiments and Variations

In an alternative embodiment, the server uses different natural language processing frameworks or emotion classification models. For example, the server may use a different sequence model for intent classification or may employ a convolutional neural network for topic identification. The underlying concept of extracting structured intent and topic information from inquiry information remains unchanged.

In another embodiment, the server uses a different type of generative information processing model, such as a sequence-to-sequence model with an explicit encoder and decoder, or a mixture-of-experts model that dynamically activates specialized sub-models based on intent information and topic information. The server still constructs prompt sentences according to the same principles and supplies context from interaction history.

In yet another embodiment, the server executes local inference using a compact generative model on an edge device or on a specialized accelerator, while using a larger, higher-capacity model in the cloud for complex or high-risk inquiries as determined by the routing rules. The server selects the model and hardware path according to a predefined performance and risk policy, further optimizing computational efficiency and network usage.

The server may also adopt alternative similarity metrics, such as Hamming distance on binary feature codes or learned similarity functions implemented as neural networks, without departing from the core concept of using feature information and similarity calculation to retrieve similar past cases.

The terminal may be a wearable device such as smart glasses. In such an embodiment, the terminal displays short pieces of response information and expert alerts in an augmented reality format. The terminal may capture user expressions and gaze direction as additional inputs, and the server may incorporate these signals into emotion analysis. This configuration improves the responsiveness and quality of in-person assistance in physical environments by leveraging the same computational framework.

Through these embodiments, the server, the terminal, and the user cooperate to realize a concrete system that improves the operation of computer-based inquiry handling, not merely automating human work but introducing new technical mechanisms for structured data representation, similarity-based reuse, emotion-aware prompting, and expert connection control.

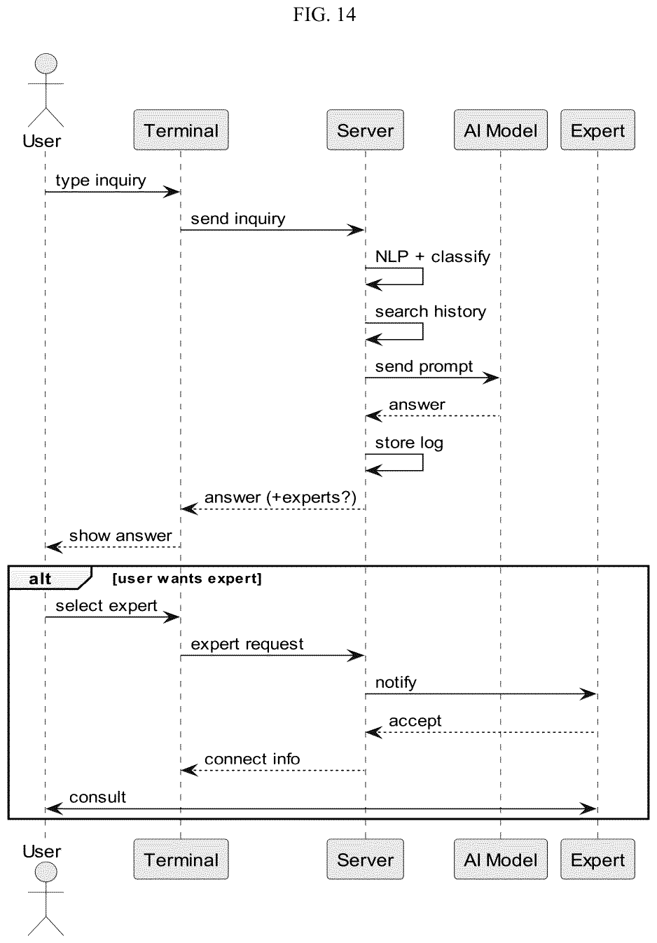

The following describes the processing flow using FIG. 14.

### Step 1:

User operates the terminal to input inquiry information.

User opens an application or web page on the terminal and enters a question or instruction as a text string, or speaks into a microphone so that the terminal converts speech to text using a speech recognition component. User may, for example, input “I am worried about the recent data leakage” or “Please propose a marketing strategy for a new product.”
Input: raw human language (spoken or typed) from the user.
Output: a structured inquiry text stored in the terminal's memory, ready to be sent to the server.

### Step 2:

Terminal generates a request payload and transmits it to the server.

Terminal embeds the inquiry text, a user identifier, a session identifier, device information, and optional media metadata (for example, audio or image references) into a request message formatted for network transmission. Terminal then sends this message to the server via a network protocol such as HTTPS.
Input: inquiry text and local metadata.
Output: a network request containing machine-readable inquiry information delivered to the server.

### Step 3:

Server receives the request and performs initial validation and logging.

Server accepts the incoming request at a defined application programming interface endpoint, decodes the message, and extracts fields such as the inquiry text, user identifier, and session identifier. Server checks for missing or malformed fields and generates a unique request identifier. Server records a log entry including timestamps, network source, and the inquiry summary in a logging subsystem.
Input: network request containing inquiry information.
Output: validated inquiry data and a request identifier stored in server memory and logs.

### Step 4:

Server performs natural language parsing on the inquiry text.

Server applies a natural language processing library to tokenize the text, assign part-of-speech tags, and identify syntactic dependencies. Server extracts entities, noun phrases, and verbs, then computes an internal representation such as a token sequence or parse tree.
Input: raw inquiry text.
Output: parsed linguistic structures including tokens, parts of speech, entities, and phrase boundaries.

### Step 5:

Server generates intent information and topic information from the parsed data.

Server applies an intent classification model to the parsed tokens. The model computes feature vectors (for example, word embeddings or n-gram features), multiplies them by learned weight matrices, and outputs probabilities for intent categories such as “security inquiry,” “legal question,” or “support request.” Server selects the category with the highest probability as intent information. Server then computes a topic label by mapping key terms or embedding vectors to domain labels using a lookup table or clustering model.
Input: parsed linguistic structures.
Output: intent information indicating the purpose of the inquiry and topic information indicating the subject domain.

### Step 6:

Server generates emotion information from textual and optional non-textual data.

Server applies an emotion classification model to the inquiry text, converting it into a sequence of token embeddings and passing them through a neural network that outputs an emotion probability distribution (for example, worry, anger, joy, neutral). Server selects the dominant emotion and stores the associated confidence. If the terminal has sent audio or image data, server processes these signals using an emotion recognition module that extracts acoustic and visual features and classifies them. Server combines the text-based and media-based results, for example by weighted averaging of probabilities, to determine final emotion information.
Input: inquiry text and optional audio/image data.
Output: emotion information representing a user emotion state and associated scores.
Step 7:

Server determines a routing result by applying predefined rule information.

Server loads a set of routing rules from a rule store, each rule specifying conditions on intent information and topic information and corresponding actions. Server evaluates conditions such as “if intent is legal question and topic is intellectual property then mark as candidate for expert routing.” Server uses logical operations to select one or more actions, such as automatic response generation only, response plus expert suggestion, or direct expert handoff.
Input: intent information and topic information.
Output: a routing result indicating selected processing functions and whether expert selection is required.

### Step 8:

Server stores interaction-related data and computes feature information.

Server writes a record into an interaction history structure in a storage device, associating the request identifier, user identifier, inquiry text, intent information, topic information, emotion information, timestamps, and routing result. Server then computes feature information from the inquiry text and analysis results; for example, server calculates a dense vector using an embedding model or a sparse representation such as a term frequency-inverse document frequency vector. Server stores this feature information linked to the interaction record.
Input: inquiry text, intent information, topic information, emotion information, and routing result.
Output: a persistent interaction record and associated feature information stored in the information recording device.

### Step 9:

Server searches for similar past cases using similarity calculation on feature information.

Server retrieves feature information for the new interaction and queries the feature store for nearest neighbors. Server computes similarity scores, such as cosine similarity, between the new feature vector and stored vectors, using vector arithmetic. Server selects records whose similarity exceeds a threshold or belong to the top ranked results. Server then retrieves corresponding past inquiry texts and response information.
Input: feature information of the new interaction.
Output: a set of similar past cases including their inquiry and response information.

### Step 10:

Server constructs a context-enhanced prompt sentence for the generative AI model.

Server generates a base instruction string and appends the current inquiry text, intent information, topic information, and emotion information. Server further appends summaries or excerpts of response information from the similar past cases as examples or reference context. Server forms a single prompt sentence or message sequence that clearly instructs the generative AI model how to respond. For example, server constructs a prompt sentence such as:
“The user said: I am worried about the recent data leakage.
Detected intent: security information request.
Detected topic: data protection and leakage.
Detected emotion: worry.
Similar past answer: [past response text].
Instruction: Generate a response that begins with an apology for causing concern, explains basic data protection measures, and optionally suggests consultation with a data protection expert, taking into account the similar past answer without copying it verbatim.”
Input: inquiry text, analysis results, and similar past response information.
Output: a structured prompt sentence ready for submission to the generative AI model.

### Step 11:

Server adjusts the prompt sentence based on emotion information.

Server examines the emotion information and applies predefined modification rules. If the emotion indicates worry or anger, server inserts explicit instructions into the prompt to use empathetic and apologetic tone and to provide clear reassurance. If the emotion indicates joy or satisfaction, server instructs the model to reinforce positive feedback. Server rewrites or augments specific segments of the prompt sentence while preserving the core inquiry content.
Input: initial prompt sentence and emotion information.
Output: an emotion-adjusted prompt sentence tailored to the user's emotional state.

### Step 12:

Server sends the prompt sentence to the generative AI model and obtains response information.

Server transmits the prompt sentence to a generative AI model endpoint, along with inference parameters such as temperature and maximum token count. The model executes a sequence of matrix multiplications and attention operations to compute output token probabilities and decodes them into a natural language response. Server receives the generated text as response information and associates it with the request identifier.
Input: emotion-adjusted prompt sentence and model parameters.
Output: response information in natural language generated by the generative AI model.

### Step 13:

Server stores the prompt sentence and response information in the interaction history.

Server updates the corresponding interaction record to include the final prompt sentence and the generated response information. Server writes these fields into the storage device, linking them to the previously stored inquiry text, analysis results, and feature information. Server may also compute additional feature information from the response text for future retrieval and analysis.
Input: prompt sentence and response information.
Output: an updated interaction history record containing all relevant data for the interaction.

### Step 14:

Server selects expert entity candidates when required by the routing result.

Server checks the routing result; if expert involvement is indicated, server queries an expert information store using the topic information and, optionally, key terms from the inquiry text. Server matches domain labels and skills attributes against the topic and computes relevance scores, for example by keyword overlap or vector similarity. Server selects expert entity candidates with the highest relevance and availability and builds a summary list.
Input: routing result, topic information, and inquiry text.
Output: a ranked list of expert entity candidates and their summary information.

### Step 15:

Server prepares and sends a response payload to the terminal.

Server assembles a response payload that includes the response information generated by the generative AI model, the detected emotion information, and, when available, the expert candidate list. Server formats this data into a message structure and transmits it back to the terminal through the communication network.
Input: response information, emotion information, and optional expert candidate list.
Output: a response message delivered to the terminal for presentation to the user.

### Step 16:

Terminal presents response information and expert candidates to the user.

Terminal receives the response message, parses it, and displays the response information on the screen as text or speech output. When expert candidates are included, terminal shows them in a selectable list, each with a brief description and a control such as a “Consult” button. Terminal may highlight the emotion-related aspects visually, such as icons or color indicators of sentiment.
Input: response message from the server.
Output: a user interface view presenting response information and expert options, and waiting for further user interaction.

### Step 17:

User selects an expert entity for consultation when desired.

User reviews the expert candidate list and, if additional assistance is desired, selects one candidate using the terminal's input interface. User may further select a preferred communication mode (for example, text chat or video call) if presented with such options.
Input: displayed expert candidate list and user choice.
Output: a user selection command specifying an expert entity and communication mode.

### Step 18:

Terminal sends the expert selection to the server.

Terminal encodes the user's selection, including identifiers for the chosen expert and the interaction, into a request message and transmits it to the server via the communication network.
Input: user selection command.
Output: a server-directed request to initiate a communication connection with the selected expert entity.

### Step 19:

Server establishes a communication connection between the user terminal and the expert terminal.

Server receives the selection request, verifies the expert's availability, and interfaces with a communication service to create a session. Server obtains session identifiers and access tokens and sends them to both the user terminal and the expert terminal. Server may also send a summary of the inquiry and previous response information to the expert terminal to provide context.
Input: expert selection request and expert information.
Output: established communication connection parameters enabling direct interaction between user terminal and expert terminal.

### Step 20:

User and expert conduct a consultation using the established communication channel.

User speaks, types, or otherwise interacts with the expert through the terminal, which sends and receives messages or audio/video streams over the established session. The expert uses a corresponding terminal to respond. Terminal continuously displays incoming information and may record session metadata locally or via the server.
Input: user messages and expert messages over the communication channel.
Output: real-time bidirectional communication between user and expert, enabling resolution of the user's inquiry beyond the initial automated response.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

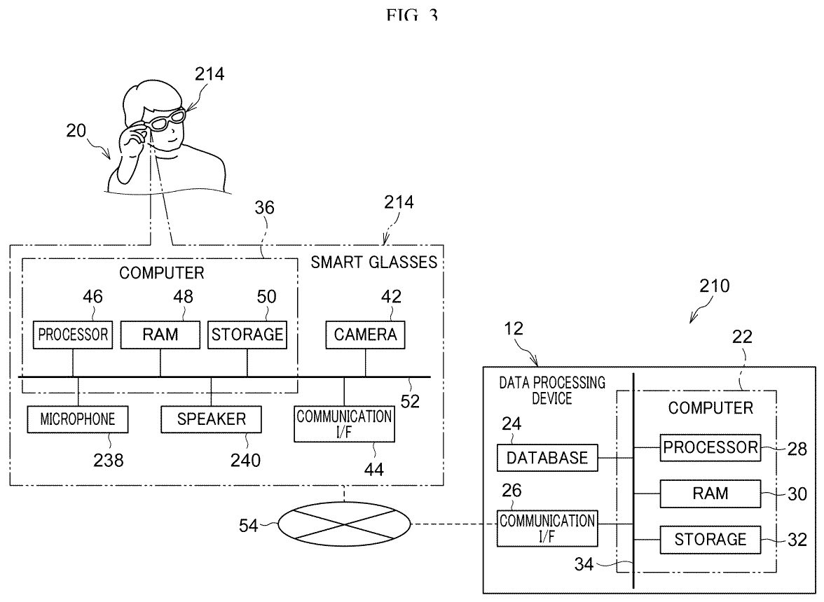

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

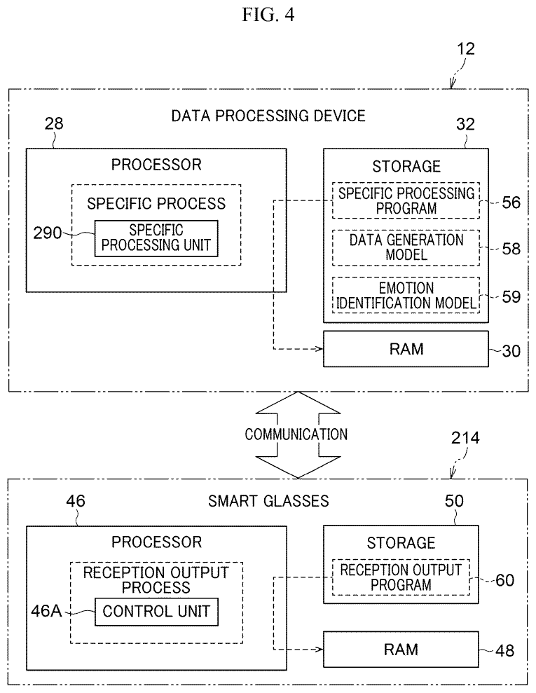

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

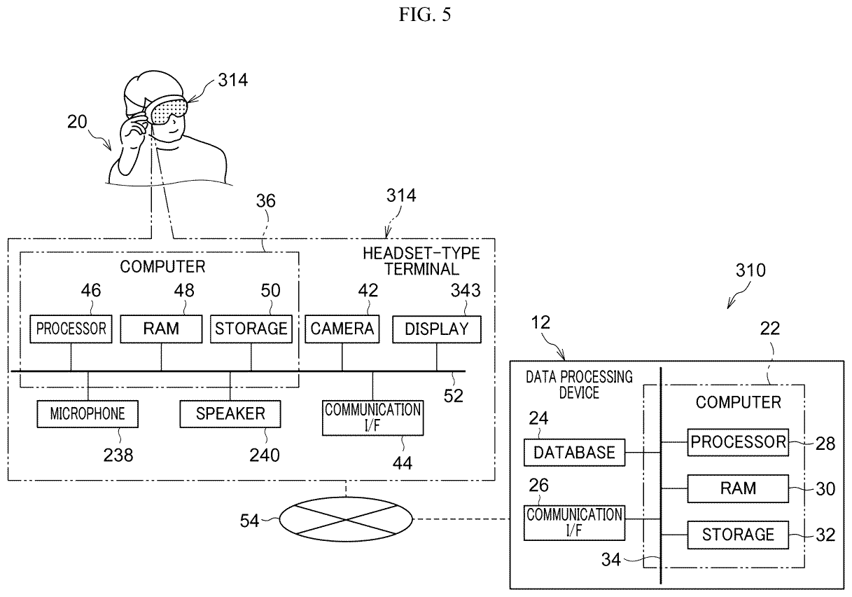

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

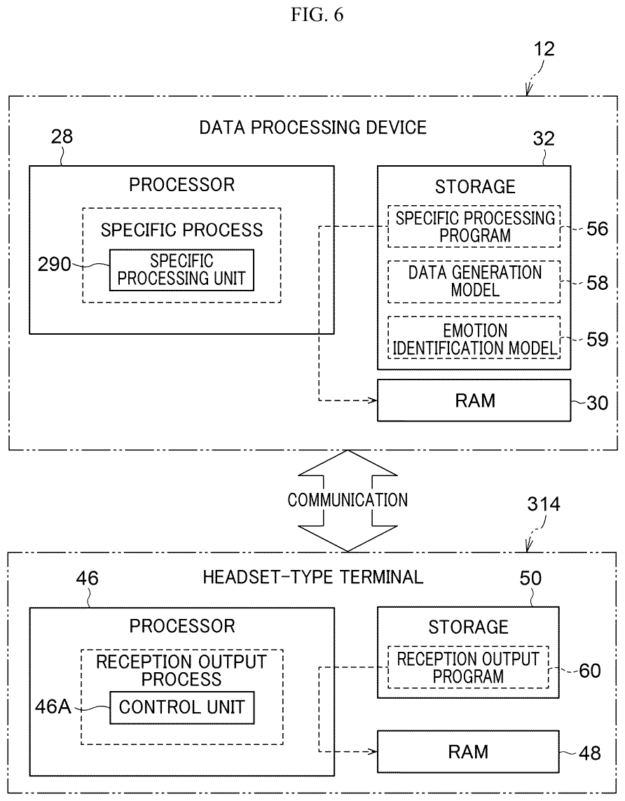

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

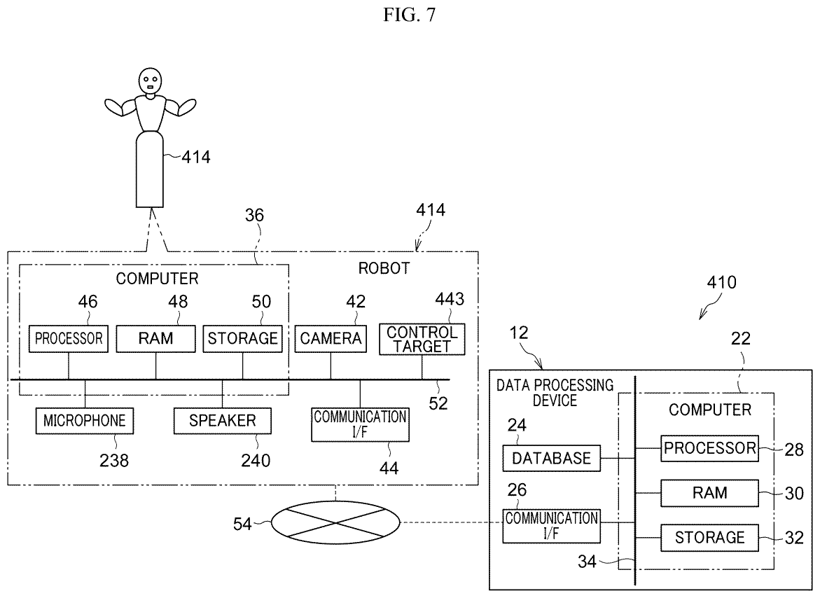

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

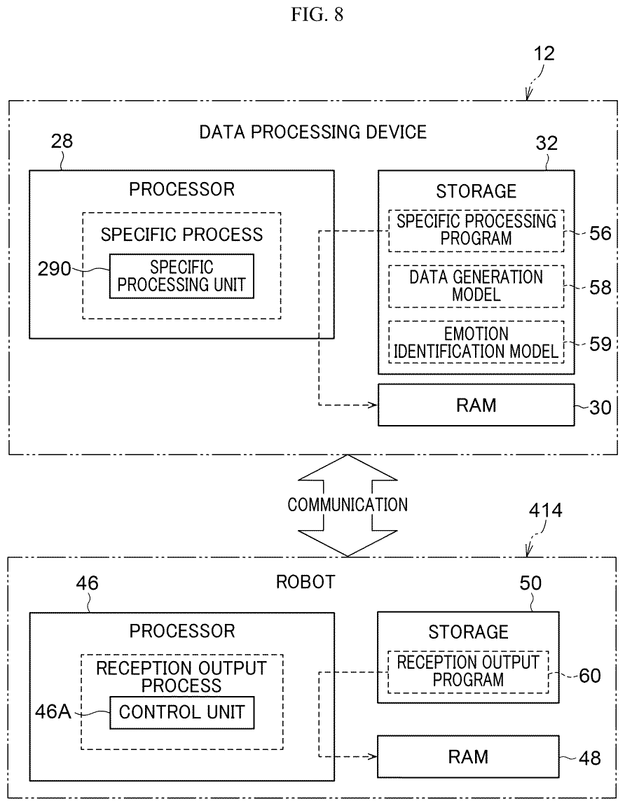

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414.

Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

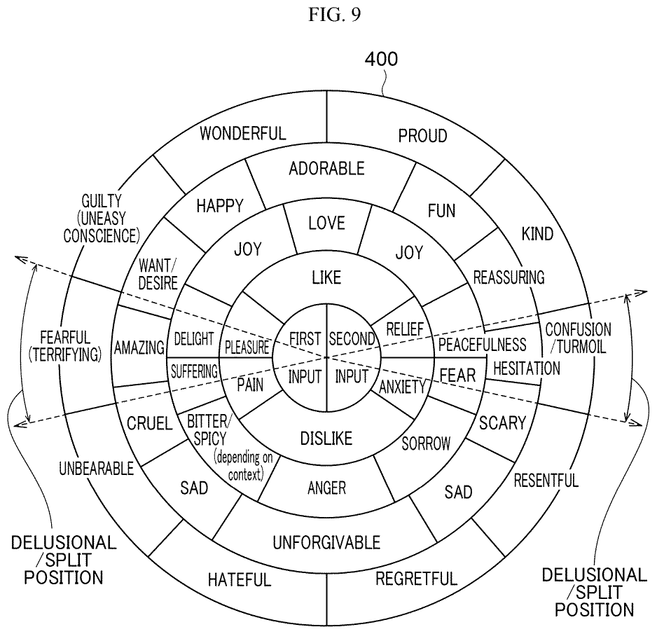

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

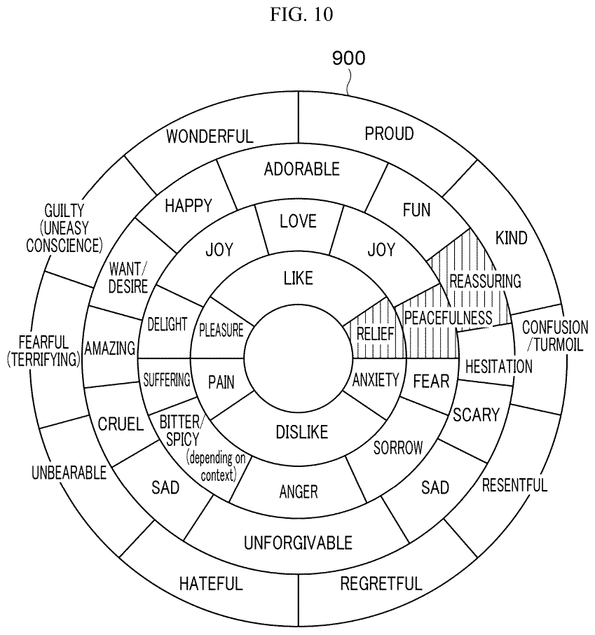

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive, via a communication interface, a prompt sentence transmitted from a user through an information processing apparatus, and parse the prompt sentence as text data to extract inquiry content,
search, based on the inquiry content, the storage device in which inquiry history and response history are stored, determine similarity between the prompt sentence and past prompt sentences by using at least one of a text similarity calculation function and a hash comparison function, and, when a past prompt sentence satisfying a predetermined condition exists, acquire response text associated with the past prompt sentence,
when the past prompt sentence satisfying the predetermined condition does not exist or
when the acquired response text is determined to be invalid by a validity determination function, generate model input data for inputting the prompt sentence into a generative AI model, transmit the model input data to the generative AI model operating on computing resources, and receive model output data including response text from the generative AI model,
execute, on at least one of the acquired response text and the response text received from the generative AI model, at least one process selected from a group consisting of text normalization processing, prohibited expression removal processing, safety determination processing, and display format conversion processing, to generate a response message to be presented to the user,
register, update, and index, in the storage device by using a database management function, the prompt sentence, the inquiry content, the response text, and metadata related to the response message,
determine, based on at least one of the inquiry content and the response text, whether the inquiry is difficult to resolve by automatic response alone by using a predefined rule set or a determination model, and, when it is determined that the inquiry is difficult to resolve,
register task information in an expert management apparatus that stores expert management information classified by field, and associate the task information with the prompt sentence and the response text to perform escalation to an expert, and
transmit, via the communication interface, at least one of the response message and a status message indicating an escalation state to the expert, to the information processing apparatus of the user.

### Supplementary 2

The system according to supplementary 1,
wherein the processor is configured to
calculate text embedding vectors for a plurality of prompt sentences stored in the storage device, numerically calculate similarity between the text embedding vectors and a text embedding vector of a newly received prompt sentence by using vector search, and select the past prompt sentence and the response text based on the similarity, thereby generating the response message rapidly without re-computation by the generative AI model.

### Supplementary 3

The system according to supplementary 1,
wherein the processor is configured to
execute sentiment analysis processing using natural language processing technology on at least one of the inquiry content and the response text, and dynamically control at least one of input content to the generative AI model, conditions for escalation to the expert, and a style and an expression of the response message to be presented to the user, based on a result of the sentiment analysis processing.

### Application Example 1

### Supplementary 1

A system comprising a processor,
wherein the processor is configured to
receive inquiry information expressed in natural language transmitted from a user terminal, and extract intent information and attribute information from the inquiry information,
search, based on the intent information and the attribute information, past inquiry history information and response history information associated with user identification information from a group of history information stored in an information storage device, and generate or update user profile information representing preference information of a user,
construct a prompt sentence to be input to a generative artificial intelligence model based on the user profile information and the past inquiry history information, the prompt sentence including current inquiry information, the user profile information, and past response history information,
cause the generative artificial intelligence model to generate response information by inputting the prompt sentence to the generative artificial intelligence model, and store the response information in association with the inquiry information and the user identification information in the information storage device, and
transmit the response information to the user terminal and provide the response information in a format displayable on the user terminal.

### Supplementary 2

The system according to supplementary 1,
wherein the processor is configured to
construct the prompt sentence to be input to the generative artificial intelligence model by extracting, from the group of history information, a plurality of inquiry history information items having high semantic similarity to the current inquiry information, generating summaries of the plurality of inquiry history information items and corresponding response history information, and including the summaries in the prompt sentence, thereby improving generation accuracy and response speed of the response information by the generative artificial intelligence model.

### Supplementary 3

The system according to supplementary 1,
wherein the processor is configured to
cause the generative artificial intelligence model to generate, based on the preference information, the attribute information, and the history information included in the user profile information, response information including, in addition to direct answer information to the current inquiry information, related information or recommendation target information matching the preference information of the user, and provide the response information including the related information or the recommendation target information to the user terminal.

### Example 2

### Supplementary 1

A system comprising a processor,
wherein the processor is configured to
receive, from a terminal operated by a user, a prompt sentence and acquire the prompt sentence as analysis target data,
input the prompt sentence into a natural language processing program and analyze content of the prompt sentence by extracting at least one keyword or important phrase,
identify, on the basis of an analysis result and a predefined decision rule, a problem field or an expert field corresponding to the prompt sentence, and search, from an information recording device, a candidate expert associated with the problem field or the expert field,
manage the information recording device as a storage device by a data management program, and store, in the information recording device, past interaction histories with a generative AI model, the prompt sentence, the analysis result, and attribute information relating to the candidate expert, such that the generative AI model is allowed to refer to the information recording device,
generate, for the generative AI model, a prompt including the prompt sentence and at least one of a related interaction history or expert information acquired from the information recording device, execute response generation processing by the generative AI model on the basis of the prompt, and store a response result in the information recording device in an append manner, and
evaluate information of the candidate expert obtained as a search result on the basis of an evaluation rule, perform at least one of selection or ranking on the candidate expert, and provide information of the selected or ranked expert to the terminal.

### Supplementary 2

The system according to supplementary 1,
wherein the processor is configured to
refer to past prompt sentences, response results of the generative AI model, and expert information stored in the information recording device, estimate at least one of a solution candidate or an expert candidate on the basis of a past inquiry similar to a currently received prompt sentence, and reflect an estimation result in at least one of input to the generative AI model or output to the terminal.

### Supplementary 3

The system according to supplementary 1,
wherein the processor is configured to
analyze state information of the user from expressions included in the prompt sentence by using a natural language processing technique, and add an analysis result as a part of a prompt to be supplied to the generative AI model so that the generative AI model generates at least one of an adjusted response or expert information in accordance with the state information.

### Application Example 2

### Supplementary 1

A system comprising a processor,
wherein the processor is configured to
receive inquiry information input from a user terminal and analyze the inquiry information by natural language processing to extract intent information, topic information, and emotion information,
apply predefined rule information based on the intent information and the topic information obtained by the analysis to determine a processing route for the inquiry so as to route the inquiry to an appropriate processing function or to a response entity having specialized knowledge,
construct a prompt sentence for instructing a generative information processing model to generate a response, the prompt sentence being based on the inquiry information and the analysis result, and cause the generative information processing model to generate response information expressed in natural language,
store, in an information recording device, the inquiry information, the analysis result, the prompt sentence, and the response information in association with one another as interaction history, and calculate and store feature information associated with at least the inquiry information or the analysis result,
search, when new inquiry information is received, the interaction history in the information recording device for similar past cases by similarity calculation based on the feature information, and dynamically generate a prompt sentence that includes response information of the similar past cases as input context for the generative information processing model, thereby improving accuracy and speed of response generation,
adjust the prompt sentence for the generative information processing model based on the emotion information so that the generated response information has a response style and expression content corresponding to a user emotion state, and
extract, based on the response information, candidates for a response entity having specialized knowledge corresponding to the topic information from an expert information recording device, present the candidates to the user terminal, and control a communication connection between the user terminal and a terminal of the response entity in accordance with selection of a candidate by a user.

### Supplementary 2

The system according to supplementary 1,
wherein the processor is configured to refer to the interaction history and the feature information stored in the information recording device and to provide a solution for the new inquiry information rapidly by using response information of the similar past cases obtained by the similarity calculation either without modification or with partial modification.

### Supplementary 3

The system according to supplementary 1,
wherein the processor is configured to identify the user emotion state as the emotion information by integrating a language analysis result for text data and an emotion estimation result for audio data or image data, and to change instruction content of the prompt sentence for the generative information processing model in accordance with the user emotion state so that the generated response information includes at least one of an expression of gratitude, an expression of apology, and an expression of reassurance.

What is claims is:

1. A system comprising:
circuitry configured to
receive, via a communication interface coupled to a packet-switched network, text data from a terminal device,
apply a natural language processing algorithm to the text data to extract classification information and feature information,
compute, based on the feature information, a similarity score between a vector representation of the text data and a plurality of vector representations stored in a storage device, and when the similarity score satisfies a predetermined threshold, retrieve associated response data from the storage device,
construct a prompt sentence for a generative neural network model based on the classification information and the text data, and input the prompt sentence to the generative neural network model to generate response data when the similarity score does not satisfy the predetermined threshold,
apply a predefined rule set to the classification information to generate routing information identifying a processing path for the text data, and
transmit the response data and the routing information to the terminal device for display via a graphical user interface.

2. The system according to claim 1, wherein the circuitry is further configured to parse the text data by performing tokenization, part-of-speech tagging, and named entity recognition to generate the classification information and the feature information.

3. The system according to claim 2, wherein the circuitry is further configured to compute the vector representation of the text data by inputting the text data to a transformer-based encoder model to generate a fixed-length embedding vector.

4. The system according to claim 3, wherein the similarity score is computed by calculating a cosine similarity between the fixed-length embedding vector and each of the plurality of vector representations stored in the storage device, and selecting a stored vector representation having a highest cosine similarity value.

5. The system according to claim 4, wherein the circuitry is further configured to determine validity of the retrieved associated response data by comparing a timestamp associated with the retrieved response data against a predetermined time window, and when the retrieved response data exceeds the predetermined time window, to construct the prompt sentence for the generative neural network model.

6. The system according to claim 1, wherein the circuitry is further configured to execute, on the response data, at least one post-processing operation selected from text normalization processing, prohibited expression removal processing, safety determination processing, and display format conversion processing to generate a response message.

7. The system according to claim 6, wherein the safety determination processing comprises inputting the response data to a classification model configured to detect content that does not comply with predetermined safety criteria, and when non-compliant content is detected, replacing the non-compliant content with predetermined alternative content.

8. The system according to claim 1, wherein the circuitry is further configured to register, update, and index in the storage device, using a database management function, the text data, the classification information, the response data, the vector representation, and metadata associated with the response data.

9. The system according to claim 1, wherein the routing information identifies at least one of an automated processing function and an entity having specialized knowledge in a domain corresponding to the classification information, and the circuitry is further configured to determine, based on the classification information and the response data, whether the text data requires handling by the entity having specialized knowledge.

10. The system according to claim 9, wherein the circuitry is further configured to register task information in a management apparatus that stores management information classified by domain, and to associate the task information with the text data and the response data to perform escalation to the entity having specialized knowledge.

11. The system according to claim 10, wherein the circuitry is further configured to evaluate candidate entities obtained from the management apparatus by applying an evaluation rule that computes a relevance score based on at least one of keyword overlap, domain matching, and performance metrics, and to rank the candidate entities based on the relevance score.

12. The system according to claim 1, wherein the circuitry is further configured to execute sentiment analysis processing on the text data using a sentiment classification model to generate emotion information, and to adjust at least one of the prompt sentence and a style of the response data based on the emotion information.

13. The system according to claim 12, wherein the sentiment classification model comprises a neural network configured to receive tokenized text data and output probability values for a plurality of sentiment categories, and the circuitry selects a sentiment category having a highest probability value as the emotion information.

14. The system according to claim 13, wherein the circuitry is further configured to, when the emotion information indicates a negative sentiment, modify the prompt sentence to include an instruction directing the generative neural network model to generate response data using empathetic language.

15. The system according to claim 1, wherein the circuitry is further configured to receive, from the terminal device, inquiry information expressed in natural language related to a customer support request, and wherein the classification information comprises intent information indicating a purpose of the inquiry information and topic information indicating a subject domain of the inquiry information.

16. The system according to claim 15, wherein the circuitry is further configured to generate or update user profile information representing preference information of a user based on past interaction history stored in the storage device, and to include the user profile information in the prompt sentence.

17. The system according to claim 16, wherein the circuitry is further configured to extract, from the past interaction history, a plurality of interaction records having high semantic similarity to current text data, generate summaries of the plurality of interaction records, and include the summaries in the prompt sentence as input context for the generative neural network model.

18. A system comprising:
circuitry configured to
receive, via a communication interface coupled to a packet-switched network, text data from a terminal device,
apply a natural language processing algorithm to the text data to perform tokenization, part-of-speech tagging, and named entity recognition, and to extract classification information comprising intent information and topic information,
compute a vector representation of the text data using a transformer-based encoder model, and perform a similarity search against a plurality of stored vector representations in a storage device to identify similar past interaction records,
construct a prompt sentence for a generative neural network model, the prompt sentence comprising the text data, the classification information, and response data from the identified similar past interaction records as input context,
input the prompt sentence to the generative neural network model to generate response data,
execute sentiment analysis processing on the text data using a sentiment classification model to generate emotion information, and adjust at least one of content and style of the response data based on the emotion information,
apply a predefined rule set to the classification information to generate routing information, and when the routing information indicates that the text data requires handling by an entity having specialized knowledge, search an entity information store to identify candidate entities and rank the candidate entities by a relevance score, and
transmit the response data, the routing information, and information identifying ranked candidate entities to the terminal device for display via a graphical user interface.

19. The system according to claim 18, wherein the circuitry is further configured to control establishment of a communication connection between the terminal device and a terminal of a selected candidate entity based on a selection received from the terminal device.

20. A method comprising:
receiving, via a communication interface coupled to a packet-switched network, text data from a terminal device,
applying a natural language processing algorithm to the text data to extract classification information and feature information,
computing, based on the feature information, a similarity score between a vector representation of the text data and a plurality of vector representations stored in a storage device, and when the similarity score satisfies a predetermined threshold, retrieving associated response data from the storage device,
constructing a prompt sentence for a generative neural network model based on the classification information and the text data, and inputting the prompt sentence to the generative neural network model to generate response data when the similarity score does not satisfy the predetermined threshold,
applying a predefined rule set to the classification information to generate routing information identifying a processing path for the text data, and
transmitting the response data and the routing information to the terminal device for display via a graphical user interface.
